(19) United States
(12) Patent Application Publication
(10) Pub. No.: US 2025/0265080 A1
(43) Pub. Date: Aug. 21, 2025

(54) PROCESSING ARCHITECTURE FOR FUNDAMENTAL SYMBOLIC LOGIC OPERATIONS AND METHOD FOR EMPLOYING THE SAME

(71) Applicant: The Trustees of Dartmouth College, Hanover, NH (US)

(72) Inventors: Richard H. Granger, Jr., Lebanon, NH (US); Antonio M. Rodriguez, Hanover, NH (US); Elijah F. W. Bowen, Hanover, NH (US)

(21) Appl. No.: 18/856,568

(22) PCT Filed: Mar. 24, 2023
(86) PCT No.: PCT/US23/16336

§ 371 Date: Oct. 11, 2024

Related U.S. Application Data
(60) Provisional application No. 63/330,177, filed on Apr. 12, 2022.

(51) Int. Cl. G06F 9/30

(52) U.S. Cl. CPC G06F 9/3001; G06F 9/30029

(57) ABSTRACT

This invention provides a system and method for processing data that includes a processor arrangement adapted to handle rich multivariate relational data from sensors or a database in which the relations are implicit. The processor arrangement can be adapted to learn composable part-whole and part-part relations from data, and matches against new data. The relations are composable into symbols of value for distinguishing or associating datapoints, and the symbols can correlate with business and personal use cases, and more particularly hand-written digits or a credit score. Operations of the processor can be defined by a formality, such as Hamiltonian Compositional Logic Networks (HNet). The operations can compare each input to a data model, stored in component parameters and connectivity. Also, operations can be carried out via extremely low-precision processing. Hamiltonians can be implicit, explicit, and/or exact. The processor can perform learning operations that are symbolic, local and free of gradients.

### RELATED APPLICATION

This application claims the benefit of co-pending U.S. Provisional Application Ser. No. 63/330,177, entitled PROCESSING ARCHITECTURE FOR FUNDAMENTAL SYMBOLIC LOGIC OPERATIONS AND METHOD FOR EMPLOYING THE SAME, filed Apr. 12, 2022, the teachings of which are incorporated herein by reference.

### STATEMENT REGARDING FEDERALLY SPONSORED RESEARCH OR DEVELOPMENT

This invention was made with U.S. government support under Grant Number N00014-21-1-2290, awarded by Navy/ONR. The government has certain rights in this invention.

### FIELD OF THE INVENTION

This invention relates to computer processing systems and methods, and more particularly to processing architectures for such that increase computational efficiency and concomitant power consumption.

### BACKGROUND OF THE INVENTION

### A. Need and Exemplary Use Cases

Many battery-powered devices in the internet of things (IoT) run always-on in the background. These IoT devices are increasingly ubiquitous, from always-on, edge AI listening systems (such as Amazon's Alexa), to implanted medical sensors (such as heart monitors). The current IoT market is in the hundreds of billions, expected to be trillions within five years. The more power any IoT device consumes, the shorter it can keep running, so architectures are pressured to be power-efficient (as well as cost-efficient). Standard computer hardware typically requires high energy budgets, so any system that is intended to run for a long time without being plugged in, can only be an extremely simple system, in order to keep its power budget acceptably low.

Notably, autonomous cars are beginning to reach affordable market prices, whereas flying drones are not yet remotely capable of the same capabilities for the same costs. The divergence between these is directly because of size, weight, and power budgets. Whereas a car can carry the huge and power-hungry processors required to operate complex perceptual processing systems, untethered robots and especially drones cannot. Deployment of advanced, completely autonomous drones will require a processing system so lightweight and power-efficient that it is not within contemplation of current approaches.

Finally, the market for data-center AI has skyrocketed, and continues to grow. Data-center AI runs deep learning and machine learning algorithms to improve web search, transcribe speech, improve self-driving cars, select job applicants, and much more. A data center is not limited by battery power. However, data-center AI consumes massive amounts of power, forming a considerable percentage of total costs.

### B. Conventional Approaches—CPUs and GPUs

The above computing needs/tasks are most commonly fulfilled by traditional von Neumann architectures, such as the prototypical x86 central processor unit architecture “conventional CPU” of Intel and AMD. IoT devices use shrunken versions of conventional CPUs. These architectures use less power because they possess smaller caches and memories, lower bit-width instructions, and simpler instruction sets (e.g. MIPS). Self-driving vehicles and data-center AI often use graphics processing units (GPUs), which can perform many floating-point operations in parallel.

In the above use cases, transistors and energy are wasted. These CPUs and GPUs are typically general-purpose von Neumann architectures, in which a long arbitrary string of instructions is loaded from central memory and executed on data that is also in central memory. The classic von Neumann architectures of present-day CPUs is well suited for general-purpose computing which is largely sequential. The arbitrariness of the instructions grossly limits the optimality of the hardware for any specific application, and the overhead of indexing and communicating with a central memory module creates a bottleneck that can slow down simple operations by many orders of magnitude. The partial solution employed by companies such as Intel, AMD, and NVIDIA is to dedicate the majority of transistors to memory caches-another cost in energy and transistors.

(1) Conventional ANNs

Artificial neural networks 100 (ANNs; e.g. FIG. 1) do not generally lend themselves to efficient computation in hardware:
(i) floating point operands: (a) are slow to operate; (b) employ a large number of transistors to store and operate: (c) require high memory bandwidth
(ii) algorithms are expressed in terms of von Neumann code, which can't take advantage of several factors in which: (a) intermediate variables do not typically need to be written to memory-such can simply be sent to a later computation, if there were a mechanism to do that; and (b) each sub-task operates partially on its own private memory. Conventional designs require that this memory be stored in the public pool, which is expensive to index and slow to read from.

(2) ANNs (Grossberg 1976; McCulloch & Pitts 1943; Rosenblatt 1958; Rumelhart & Zipser 1985; Werbos 1974; Widrow & Hoff 1960; others) derive from a surprisingly constrained set of specific linear-algebra premises. 80 years ago, McCulloch & Pitts (McCulloch & Pitts 1943) defined a basic ANN, and present-day networks continue to cleave remarkably closely to those initial formulations. In current ANNs, such as most “deep learning” nets:

(a) Neuron activity is scalar (rationals).

(b) Synaptic weights are scalars (rationals).

(c) A neuron is excited if the sum of the products of its active inputs and weights exceed a scalar threshold.

(d) Weights change via simple rules (e.g., a modified LMS rule for deep learning).

(e) There are no distinctions between excitatory and inhibitory cells. (Sign of activation determines excitation or inhibition).

(f) All cells and synapses can operate independently and in parallel unless otherwise specified in the LMS operation.

Various forms such as reinforcement learning have some variants on these rules, but all continue to adhere to a remarkably subset of the attributes of brains. It is not well understood whether other properties of brains might confer additional computational power to artificial systems.

It is desirable to employ such characteristics to overcome the above-recited disadvantages of conventional von Neumann and related computer processing architectures and associated instantiated software algorithms running thereon.

### SUMMARY OF THE INVENTION

This invention overcomes disadvantages of the prior art by providing a system and method for data processing that comprises a processor arrangement adapted to handle rich multivariate relational data from sensors or a database in which the relations are implicit. The processing system can also define a processor arrangement adapted to learn composable part-whole and part-part relations from data, and matches against new data. Illustratively, the relations can be composable into symbols of value for distinguishing or associating datapoints, and the symbols can correlate with business and/or personal use cases—for example, hand-written digits or a credit score.

In a further illustrative embodiment, the system and method provides a processing system organized based upon a plurality of components. It can include, a processing architecture in which (a) inputs to each component, from the plurality of components, comprise an array of ≤8 bit integers, of consistent length; (b) a product of each component is a ≤8 bit scalar integer: (c) free of learning, an output of each component only changes as a function of its input; (d) each component possesses a short list of operations that, respectively, the component is capable of performing and a short list of parameters for each operation; (e) each component performs only one operation on a given input; (f) all components are capable of operating independently and in parallel; (g) components are capable of operating in sequence, or recurrently; (h) components are extremely sparsely connected; (i) connectivity is many-to-many, and defined at startup; and (j) connectivity amongst components can only change using local operations, with no (free of any) backprop. Illustratively, the components can only perform a limited set of operators, comprising, and such operators include (a) 2-way or n-way Boolean relational operators: (b) e.g. ≤8-bit integer or unsigned integer addition; and (c) comparison of above results: argmax, argmin. A subset of the primitive operations can be composable and reversible/decomposable. Illustratively, operations of the processor architecture are defined by a formality, and that formality can comprise Hamiltonian Compositional Logic Networks. The operations can serve to compare each input to a model of data, stored internally in component parameters and connectivity. Matching operations can be performed by the processing architecture, and such matching undergo reduction steps that convert arrays to shorter arrays or scalars-which can define at least one of (a) k-winner-take-all, (b) thresholding, (c) sum, accumulate, (d) mm, argmin, max, argmax, (e) find index of xth quantile, (f) univariate statistics: mean, median, mode, stddev, stderr, and (g) multivariate statistics or correlation. The processing architecture can perform operations on nearest neighbors. Notably, operations can be carried out via extremely low-precision processing. The operations use Hamiltonians that are at least one of implicit, explicit, and exact. The processor architecture can also perform learning operations, in which the learning operations are at least one of symbolic, local and free of gradients.

### BRIEF DESCRIPTION OF THE DRAWINGS

The invention description below refers to the accompanying drawings, of which:

FIG. 1 is a block diagram showing e a functional example of a convolutional artificial neural network (ANN) instantiated on a computer processing device;

FIG. 2 is a flow diagram showing an externally supplied input in original format (e.g. bitmap images, PWM audio), input-specific pre-processing, input code as specified by the current invention, distribution of inputs, component processing, a subset of processing products are used as the output code, and output code interpretation;

FIG. 3 is a listing of exemplary pseudocode for use case A herein, running on a conventional CPU of a computer processing device;

FIG. 4 is a chart showing a definition of the four binary pairs 11, 10, 01, 00 for use by the illustrative embodiment;

FIG. 5 is a diagram showing examples of a simple binary relational graph encoding of sample MNIST images, including a close-up view of pixel encoding, wherein binary (black/white) pixels are connected as per directional convention (arrows), by four types of edges and sample parts harvested from training images, and in which matching is via Hamiltonians;

FIG. 5A shows a graph with a comparative classification accuracy of a simple SVM back end, with and without a Hamiltonian Compositional LogicNetwork (HNet—described further below) processing according to the system and method herein;

FIG. 5B shows a diagram of exemplary nontopographic data, such as arbitrary abstract attribute-value pairs for association with the system and method herein;

FIG. 5C shows a diagram showing a closeup of an exemplary credit application data structure processed in accordance with the system and method herein;

FIG. 6 is a group of tables showing energy values E(s) for each of four possible states of binary pairs derivation of the values therefrom, visualization of the meanings of positions a, b, and c within the 2×2 H matrix, Hamiltonian entries, representing each of the logical relations and visualization of the four atomic Hamiltonian matrices used in the preferred embodiment;

FIG. 7 is a pair of tables showing logical operators, in terms of the four fundamental operators AND, NCONV, NIMPL, and NOR and Hamiltonians for all 16 operators:

FIG. 8 is a group of tables showing the simplest possible HNet graph, with two nodes (pixels) and one edge equations for constructing a composite H, the composite Hamiltonians used in this operation, a second example HNet graph, with two edges, possible values for Hamiltonian matrix elements in the case of all possible consistent logical relation pairs and an equation resultant from the foregoing;

FIG. 9 is a simple graph denoting three learned nodes and edges, to illustrate composing the Hamiltonians of XY, XZ, and YZ into a single Hamiltonian for XYZ, a table of the three projection operators, construction of the three Hamiltonians and construction of the total/composite Hamiltonian;

FIG. 10 is a diagram showing an example of a connectedpart component, drawn on the pixel nodes of an MNIST image, an example of a shared, cross-class connected part component and examples of four discriminative connected part components (each pair shaded differently), and each of which matches one class of digit and not others;

FIG. 11 is a listing of pseudocode for the software algorithm Ai according to an illustrative embodiment at training time, including Algorithm Ai stage 1 and Algorithm Ai stage 2; and a listing of pseudocode for the software algorithm Ai according to an illustrative embodiment at testing time according to the illustrative embodiment, including Algorithm Ai stage 3, Algorithm Ai stage 4; and Algorithm Ai stage 5;

FIG. 12 is a schematic diagram summarize hardware functionality for an embodiment performing algorithm Ai of FIG. 11 at testing time with associated functions

FIG. 13 is a listing of pseudocode for algorithm Aii according to an embodiment at training time (algorithm simplified by the removal of competition amongst parts), and associated functions;

FIG. 14 is a listing of pseudocode for algorithm Aiii according to an embodiment at training time and testing time, including algorithm Aiii stage 3, Algorithm Aiii stage 4, testing time sub-portion of algorithm Aiii, algorithm Aiii stage 5, algorithm Aiii stage 6, algorithm Aiii stage 7, and algorithm Aiii stage 8, with associated functions;

FIG. 15 shows a hardware summary for an embodiment performing algorithm Aiii at testing time and related functions;

FIG. 16 shows a listing of pseudocode for the described algorithm for use case B herein at training time, including algorithm B stage 1, algorithm B stage 2 and algorithm B stage 3, and related functions thereto;

FIGS. 17A-17E are diagrams showing simple instances of the resulting abduced entities generated according to the procedures of this system and method;

FIGS. 18A-18H are diagrams showing construction of simple “face” configuration representations, from exemplars constructed within the CLEVR system consisting of highly simplified eyes, nose, mouth features, and examination of the configurations thereof; and

FIGS. 19A and 19B, are two respective image-processing networks are depicted, which produce identical results according to the system and method.

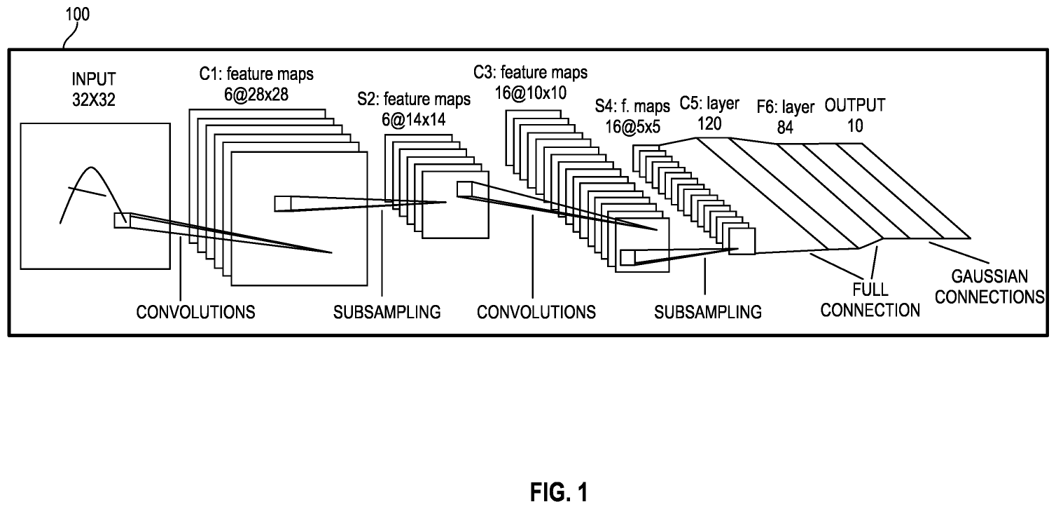

### DETAILED DESCRIPTION

### I. System Overview and Advantages

### A. Terms of Used in the Description

(1) ALU—arithmetic logic unit, a block of electronic hardware responsible for performing arithmetic.

(2) core—a self-contained processing element contained on a die with one or more other cores.

(3) component—a mathematical operation that encodes a small fixed primitive set of fundamental relations that can be directly interpreted in terms of simple logic operations.

(4) timestep—a basic time measurement for completing a computation—each component herein typically completes in one (1) timestep.

(5) Standard unit abbreviations herein include:
(a) b—bit;
(b) B—byte (8 bits);
(c) bps—bits per second;
(d) ms—milliseconds; and
(e) nm—nanometer.

### B. Discussion

ANNs struggle to produce higher level encodings such as relations (before; part-of; next-to). Such relations are crucial to representation of structure and organization; the shortcomings are well known and much discussed in the ANN literature (e.g., Marcus 2018 for review-note that all cited references, not otherwise specified, refer to the Bibliography below). For a standard ANN to capture such relations in data, it must step beyond the standard statistical calculations, to incorporate increasingly advanced composites (e.g., via convolutions, recurrences, pooling, attention windows) (see, e.g., Hinton 2021 for a recent approach). In efforts to achieve these capabilities, ANNs have often been combined with separate symbol-based systems to produce “hybrids” (see Lamb 2020 for review). A considerable conceptual advantage of ANNs is their rigorous basis in relatively straightforward mathematics. Symbolic systems tend to appear relatively ad hoc when compared with the bottom-up designs of ANNs, which are built from basic tenets such as those just listed above.

Thus, the benefit of ANNs is that they're composed from simple elements, whereas the benefit of symbolic systems is that they are capable of rich representations of multiple types of relation such as part-whole, next-to, above, and so on. This makes them generative, giving them the abilities of automatic generalization of relations to new objects, perceptual filling-in, and more.

Another key difference between ANNs and symbolic systems is that ANNs lend themselves to hugely parallel implementations, whereas symbolic systems typically do not. For example, many ANN-based applications which have recently gained popularity (real-time speech transcription, object identification in video, etc.) do not require long arbitrary strings of instructions, nor monolithic memory. This includes many sensor-processing and decision-making applications for IoT devices, drones, self-driving cars, and data centers. Each application breaks a task into many small sub-tasks, each of which can be described in very few instructions and can operate on its own independent memory. Many of these sub-tasks are independent of one another, so they operate most efficiently on an intrinsically parallel architecture.

The illustrative embodiment(s) herein (and accompanying techniques) provide a completely different approach. It builds on comparatively underexplored attributes of neuroscience, attempting to exploit brain circuit characteristics that are typically not included in most ANNs (particularly extreme sparse connectivity, and extremely low precision arithmetic steps); at the same time, the introduced methods provide benefits of both ANNs and symbolic systems, basically demonstrating a way to construct arbitrary relational representations, built up from extremely simple bottom-level mathematical components. Each component of the system encodes a small fixed primitive set of fundamental relations that can be directly interpreted in terms of simple logic operations. As a result, the relational encoding sought by symbol systems is not added on to some existing (and sometimes cumbersome) set of underlying computations, but rather the relational encoding is itself the bottom-level basic level of the network. Relations occur intrinsically within the most elemental units of the system. Each component implements a short instruction set that is used to build relational information into a network. The built-in fundamental logic operations are constructed to have specific properties: all operations, including large and arbitrarily composited structures, are reversible, not lossy; retain relational information of the sort typically wanted in knowledge structures; and provide a surprisingly simple mathematical basis for constructing the resulting large knowledge representations.

The system, thus, defines unusual characteristics. It is not von Neumann; it is not a Turing machine; it cannot perform arbitrary code execution expected of a computer's conventional CPU; it does not process fractions (e.g., float32) or large integers (e.g., int32), making it a poor fit as a conventional numeric calculator or for some scientific and graphics applications. Instead, it contains a large number of simple processor-memory unit operators (termed “components”) (see below), each with its own memory. One or several components maps onto a single application-specific sub-task.

Data (such as images or sounds) are straightforwardly encoded as graphs, whose edges correspond to relational codes from the prespecified small fixed set of elemental operators. Components calculate matches among different inputs by a newly introduced graph Hamiltonian, whose ground state represents those values for which all relations among vertices are simultaneously satisfied. All numeric steps in the method scale linearly with the number of edges in the data, and are readily implemented in appropriate massively parallel hardware. The resulting unconventional neural architecture can achieve standard ANN functions at very low computational cost.

The fundamental operations enable simple, theoretically grounded (well understood) learning rules, examples of which are provided in later sections. They form a representation that lends itself to learning algorithms that build up relational explainable representations. This is bottom-up construction of a symbol system from logic.

The components are arranged in a graph topology which allows for a reconfigurable network and flexibility for the user. The connections between input bits and components, and amongst components, can be programmed to match sub-task dependencies. These connections are required to be sparse: i.e., most such possible connections are zero (As described later, this corresponds to the pair 0-0, or a logical ‘NOR’.) The sparseness enables further architectural optimizations (see Detailed Description). All of the components operate in parallel. Serial dependencies (in which the output of one step is necessary input to a next step) are implemented by connectivity.

Additionally, the invention is capable of representing simple logical structure of a kind that is still highly elusive to typical ANNs-such as explanatory representations of where and why a new instance fails to match leaned data. If the operations of a deep task are reversible (as well as relational), this also renders them explainable.

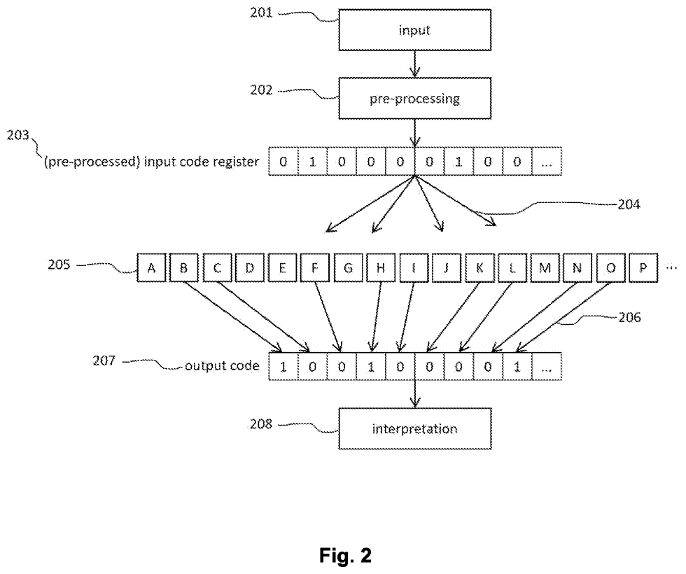

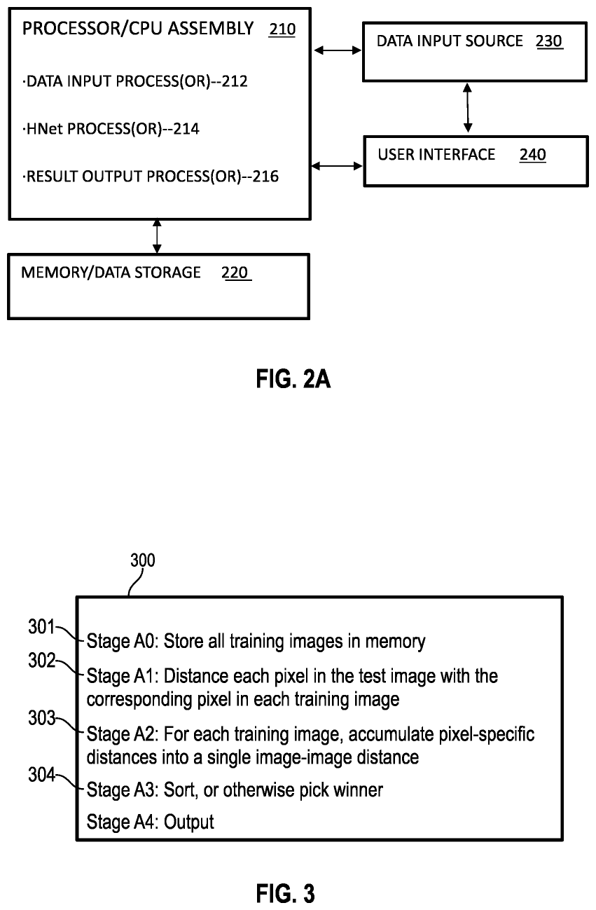

Note that similar novel computing processor and operating system architecture is shown and described in commonly assigned U.S. patent application Ser. No. 17/588,168, entitled MULTI-CORE PROCESSING AND MEMORY ARRANGEMENT, filed Jan. 28, 2022, the teachings of which are incorporated by reference as useful background information. The processing architecture herein (and as shown in the above-incorporated application (e.g. FIGS. 2-4 of that application), and/or otherwise clear to those of skill) can contain appropriate wired and wireless network communication modules/adapters, user interface devices—including a graphical user interface (GUI) in the form of a display, touchscreen, keyboard and/or mouse, and other functional processes/ors for implementing a standalone or distributed (e.g, cloud) computing arrangement.

By way of non-limiting example. FIG. 2A depicts a schematic representation of a computing environment/arrangement for carrying out the processes of the illustrative system and method herein. Generally, the arrangement consists of an appropriate processing/processor 210 that can be implemented in accordance with the above-referenced architecture, or another appropriate architecture. The process(or) 210 implements a plurality of conventional a custom functional processes/modules that, in simplified form are represented as a data input process(or) 212, a HNet process(or) 214 and a result output process(or). As should be clear to those of skill, the depicted (exemplary) organization of functional modules is exemplary of a wide range of possible organizations for functions/processes/ors herein, and can be varied and/or supplemented with further processes/ors as appropriate to carry out the functions of the system and method. The process(or) 210 interacts with a memory structure 220 that can be provided remote from the processor arrangement or as an onboard modules/processes/ors as appropriate. The memory 220 stores and transfers data, instructions and results (among other information), as appropriate. The arrangement also includes a data input source 230 that can be part of, and/or separated from a user interface 240. The data source 230 can provide manually and/or electronically generated data (via keyboards, touchscreens scanners, sensors, etc.). Data input, handling and results are manipulated by the user interface 240. All physical/functional modules/processes/ors in the arrangement of FIG. 2A can be interconnect by appropriate wired and/or wireless data communication links, operating in conformance with relevant communications protocols, which should be clear to those of skill.

### 1. Brain-Inspired Aspects of the Architecture

The neuron or nerve cell of the brain can be thought of as the brain's basic computing unit. Neurons exhibit characteristics that are extraordinarily odd from any engineering point of view. There is powerful evidence that neurons and their I/O synapses are extremely low-precision. In addition, neurons are very sparsely (rarely) connected. Unlike conventional processors from manufacturers such as ARM and Intel that use a few fast processor cores with cycle times clocking less than a nanosecond, brains rely on billions of neurons and trillions of synapses that operate in parallel as extraordinarily slow components, clocking milliseconds at best. The massive parallelism of brain operations apparently overcomes these seemingly insurmountable speed deficits, enabling brains to routinely outperform standard computing systems on a wide range of tasks.

The illustrative embodiment employs these characteristics in the design of the system and method herein, wherein aggregate throughput is important but the computations are highly latency tolerant, so that no individual components need to run very fast. The combination of slow memories with slow processing components achieves extreme power efficiency. Comparable efficiencies are generally not at all possible when processor cores and memories are required to run at sub-nanosecond speeds (unlike brain speeds).

A cell's response is assumed to be a straightforward function of the sum of products of its inputs and synapses, but the precision of cells and synapses is rarely considered; reducing all high-precision scalars and vectors in these models to primitive binary relations would profoundly change their computations.

By contrast, this novel form of neural network implements a strictly fixed set of primitive binary operations that are in many ways consistent with low-precision synaptic and cell biology; these are in turn interpretable in terms of logic relations that are shown to greatly expand the set of computations that can be executed, including hierarchical representation and part-whole relations, all without any error correction mechanisms nor any non-local propagation of the kind pervasive in extant standard networks.

As noted, the brain's computational units are extremely simple, extremely low-precision, extremely sparsely connected, and extremely parallel. The brain's application code must somehow be in concord with these characteristics. This may mean splitting tasks into sub-tasks that communicate via small signed integer values, possibly corresponding with brief spiking bursts. Sub-tasks must in turn be simple; each such sub-task may be considered a parametric function of other sub-tasks. The basic architecture can then be programmed to perform some task solely by changing the data flow amongst the sub-tasks, or by changing the (few) parameters within a sub-task. This unusual set of processing views arise naturally from the architecture of the invention. In this fashion, these biological constraints of sparseness, low precision, distributed memory, simple operations, all contribute to give rise to the novel architecture of the invention.

Thus, whereas ANNs somewhat capture the biological property of massive parallelism, the present invention is intended to capture certain additional essential characteristics of brain wetware. None of the ANN prior art is believed to teach all of (i) radical sparseness; (ii) radical low precision (every weight has ˜5 possible values); (iii) competition; (iv) learning functions that acquire symbolic representations; and (v) local learning functions (see below).

### 2. Related Approaches

Field-programmable gate arrays (FPGAs) are (see below) composed of many simple, parametrically programmable units with programmable connectivity. This makes FPGAs a salient point of comparison. However. FPGAs are very general purpose computing devices, not capturing any of the particular characteristics of brain circuitry cited here (such as sparseness or low-precision computation).

Supercomputers achieve parallelism by coordinating many conventional CPUs. Because each processing unit in a supercomputer is a very high-level machine designed to perform highly complicated tasks (not simple sub-tasks), the ideal applications for supercomputers are disjoint with those of the described invention.

Current purported neurally inspired hardware designs focus on neuron elements and synaptic connections, in a weakly-structured “neural soup” that does not exploit neural interactions in local circuits or large systems-level brain circuits. Supposed neurally inspired hardware such as the IBM True North system still, after many years, does not even exhibit learning-on-chip, but rather requires off-line learning which then is downloaded onto the chip. These greatly limit the utility of adding hardware at all. That is, the hardware accelerates neurons, but neurons themselves do not do much, unless they are in brain circuit layout architecture designs.

Despite the highly advertised successes of neurally inspired software such as deep implementations of backpropagation (deep learning=deep hackprop), there has been a notable shortfall in the ability of these algorithms to take advantage of hardware acceleration other than GPUs. There are multiple purported neuromorphic chips in progress from various sources, since most of these chips are based either simply on the units of artificial neural networks (ANNs), which exhibit highly simplified processing compared to actual neural units—and such chips universally embrace the ANN connectivity patterns of dense, all-to-all connections suitable for, e.g., backprop, that powerfully diverge from brain circuit architectures of sparse, highly specialized layouts in particular neural layers (e.g., superficial vs, middle vs, deep cortical layers), and in multiple particular brain areas. Notably absent is also the circuit design of the striatal complex, which underlies reinforcement learning. Also absent are the architectural layouts of hippocampal fields, and of systems-level cortico-hippocampal, cortico-striatal, and cortico-cortical connectivity.

Some domain-specific architectures also use parallel computation, such as Google's TPU: a matrix processor that executes massive amounts of matrix operations simultaneously. It works very well for matrix-multiplication operations. However, it does not generalize to larger classes of algorithms.

### 3. Applications

Parallel computation, in principle, enables large problems to be divided into smaller ones that can then be executed simultaneously. This powerful technique only is applicable if the operations permit simultaneous execution, but for a vast set of algorithms, there are no subdivisions that can enable this simultaneity of operations. This is not simply an implementation detail, but often intrinsic to the algorithm that underlies the software: the logical operations to be carried out may contain serial dependencies, i.e., the output of one step is necessary input to a next step. Serial dependencies rigidly prohibit parallel steps; the very operations themselves preclude simultaneous execution. Thus, parallel processing requires algorithms that are not serially dependent; i.e., the less serially-dependencies in an algorithm, the more can be executed in parallel.

It is a well-known problem in computer science that, in general, serial algorithms cannot be made parallel (parallelized) in any manner that actually speeds them up. This longstanding problem has resisted general solutions. Instead, the architecture of the invention is designed specifically to take advantage of algorithms that are intrinsically constructed as parallel algorithms—not inherently serial algorithms that are partially parallelized.

Many existing applications contain parallel sub-tasks that can be directly mapped onto components. For example, many ANNs contain large blocks of many identical sub-units, performing simple operations such as multiplication, without interdependencies.

The biology-inspired architecture disclosed herein often enables biology-inspired application code to gain even greater performance gains. The illustrative architecture is far better suited for algorithms that are derived from computations carried out by brain circuitry. Extended testing has shown that, for instance, a cortical-subcortical algorithm (CSL) (Chandrashekar & Granger 2011) achieves the same computational efficacy as ANNs in side-by-side comparisons; yet CSL is shown to do so with an order of magnitude less computational time cost, and CSL is intrinsically parallel, which would enable it to take advantage of the type of low-power massively-parallel processing system proposed herein. Such a system is possible directly because it is taking advantage of already tested algorithms that have known parallel computational cost characteristics; by basing algorithms on massively scalable actual brain circuit designs, these architectures are both neuromorphic and, more importantly, brain-circuit-morphic, i.e., based not just on characteristics of individual cells lacking organizing circuit structure, but rather on the characteristics of the circuitry in the brain that provides the organizational structure to large scale assemblies of actual neurons. Several biology-inspired applications, and how they integrate are shown in the disclosed hardware. (see below).

Brain circuit algorithms have been shown highly useful in multiple applied tasks, ranging from standard machine learning classification, to unsupervised categorization, to sequence learning, to visual and auditory perceptual tasks (See referenced below, Granger 2011; Moorkanikara et al. 2009; Chandrashekar and Granger 2012; Chandrashekar et al., 2013; Bowen et al. 2017; Granger et al. 2017; Rodriguez & Granger 2016; 2017; Jarrett et al. 2019). However, running these algorithms at present on standard machinery literally requires “serializing” the parallel algorithms, to fit the very limited parallelism in current hardware. Implementing them in appropriate novel hardware will greatly accelerate them and establish a platform for fully exploiting these proven powerful approaches.

### II. Illustrative Embodiment of Architecture and Operational Algorithms

### A. Input Specification

The current invention requires that an input be one or more sparse, binary, high-dimensional (>>3) vector. This vector is presented to the invention as an array of digital bits.

FIG. 2 shows, in block 201, externally supplied input in original format (e.g. bitmap images, PWM audio), known input-specific pre-processing operations 202, input code as required by the current embodiment 203, distribution of inputs 204, component processing 205, subset of processing products are used as the output code 206, output code 207, known output code is interpreted 208. Data in a different native format (speech audio, videos, loan applications, text, etc.). Step 201 may be converted to this format using any number of pre-processing methods 202, not claimed herein but often used in the embodiments.

For example, categorical data can be converted to binary by producing a so-called one-hot type of labeled-line code. A continuous, scalar, real-valued variable can be converted to a one-hot code via bucketing, rounding, clustering, or other methods. An image can be binarized in many ways, the simplest of which is to convert it to grayscale, then apply a thresholding operation to each pixel. This approach has been successfully used, but also found more complex methods to be valuable. Some pre-processing methods, such as those performed on Fourier-transformed audio, are heavily used but too complex to describe herein.

### A. Connectivity Specification

The illustrative embodiment contains numerous parallel operators, each called a component (205 in FIG. 2). Each component receives a subset of the input bits, determined by programmable wires (204 in FIG. 2). These programmable wires distribute input bits to components in a sparse (low fraction of connectivity), many-to-many relationship. This relationship is application-specific, and may be supplied for example as a binary source-destination masking matrix. This relationship often remains consistent across time, for a given application. However, for applications such as deep learning training, the relationship may be procedurally modified by an external co-processor or by the outputs of a subset of the components. The specific connectivity of these wires is crucial to the customization of the invention to various applications, because it determines which input bits will be considered together by a given component. For example, in image processing applications, it may be desirable to consider adjacent pixels together, as in wavelet transforms (Meyer 1992)

The simplest embodiment of programmable wiring is a wire, gated by a digital transistor gate connected to a digital latch gate. This latch is set during a startup procedure. Programmable wires may be embodied as simulations on a conventional computer, in which case conventional array indexing is used. Later sections hereinbelow describe these embodiments in more detail.

Each component produces, as output, one to several digital bits for each set of input bits that it receives. These bits together may store one bit, a one-hot code of several bits, or one ultra-low-precision integer or unsigned integer (e.g, less than or equal to an unsigned integer stored in 8-bit binary, commonly referred to as “uint8”). Note that other integer lengths can also be employed—for example non-Von Neumann processors possess typically an ability to operate with/on up to 16-bit integers. Use of 16 bits can sometimes simplify the implementation of argmin, such as when finding the min of more energies than can be indexed by an 8-bit integer.

In some instantiations of the illustrative embodiment, the programmable wires also have a capability to connect the outputs of some components to the inputs of other components. In this case, the architecture becomes hierarchical. Hierarchical architectures allow sub-tasks to be strung together in sequence. An example use case is the masked sun operation. In this example, a bank of components perform masking on an array of inputs, and a follow-up component performs a sum on the masked array. Alternately, a hierarchy may be designed such that the same set of sub-tasks are performed multiple times in sequence. For example, a tree-based search or sorting task may be broken into sub-tasks that search or sort each subset of the data array, then search or sort the results in combination. For a second example, an image may be processed to find fine-resolution patterns, after which the result is processed to find coarse-resolution patterns. This approach is common in ANN use cases, but a novel approach is described in exemplary use case A (algorithm Aiii).

Components can be circularly connected. In other words, one or more component can supply input to one or more component that supplies its input. In this case, the architecture becomes recurrent. Recurrence enables more advanced relations amongst sub-tasks. For example, a component that takes is own output as input can serve as a long-term memory store if it does not operate on its input, or as a clock if it increments its input. A component that takes its own output as input, plus an additional input, can measure the instantaneous slope of a time series function by subtracting the previous value from the current. Two or more components that provide each other with input can work together to perform more advanced operations over time. For example, one component bank can monitor another component, then provide an error signal to it. These approaches are fundamental, either implicitly or explicitly, to numerous tasks in the prior art, including tasks in the families of actor-critic models, expectation maximization, sequence learning, restricted Boltzmann machines, evolutionary algorithms, and much more. Many ANNs are recurrent, and such approaches have been successfully applied to many tasks.

### B. Output Specification

The output of the illustrative embodiment (207 in FIG. 2) is similar to the input—one or more sparse, binary, high-dimensional (>>3) vectors. This vector is returned by the invention as an array of digital bits.

While all internal components produce single-bit outputs, a subset of these components produce outputs that are accumulated the output vector (206 in FIG. 2). For a given use case, the same subset of these components are used as output at each timepoint. The output bits (207 in FIG. 2) is often be communicated to an external device by way of an intermediary protocol (e.g. Universal Serial Bus (USB) or another appropriate communication protocol).

The interpretation of the output (208 in FIG. 2) is task-dependent. At times, certain bits of the output may be precisely the control signal for a mechanical component (e.g, when bit 2 is active, motor 2 should receive power). Generally, however, the output bits must be considered holistically. The output bits may form a space in which an interpreter (e.g, a classifier or a database engine), running on a conventional CPU, makes a decision (e.g, to label the output with a class or look up a database field).

### C. Component Specification

A component is a simple logic unit. Unlike a Turing machine (Truing 1948), it only receives application-specific instruction during the startup step. The component repeats this instruction on every input. The instruction it receives is not a string of atomic operations, but a single atomic operation and associated parameters. For example, a component may be instructed, by a single instruction ID, to sum its input bits, then return the result or compare the result with an integer threshold.

The component is incapable of performing high-precision or floating-point arithmetic. It is limited to ultra-low-precision integer arithmetic (not multiplication) and Boolean logic. This yields a component with very few transistors, and a very shallow pipeline (if pipelining is used in the embodiment at all). It also increases the response time predictability of the component. Therefore, all components can easily be synced in a clocked embodiment. In most embodiments, components will spend little time waiting for other parallel components to complete.

The functionality of a single component can be severely limited in instruction variety, and processes a single instruction, not instruction sequences. This makes its programmability essentially parametric. For each component, the programmer chooses among a short list of instruction IDs, then supplies a short list of ≤8-bit parameters. A bank of components is a group of components that perform the same operation in parallel on different data. Grouping components into banks aids programmability and compiler effectiveness, because the entire bank of components performs the same operation, and only varies on connectivity (and, at times, parameters). In principle, each calculation could be a table lookup. Below, an embodiment of such an approach is shown.

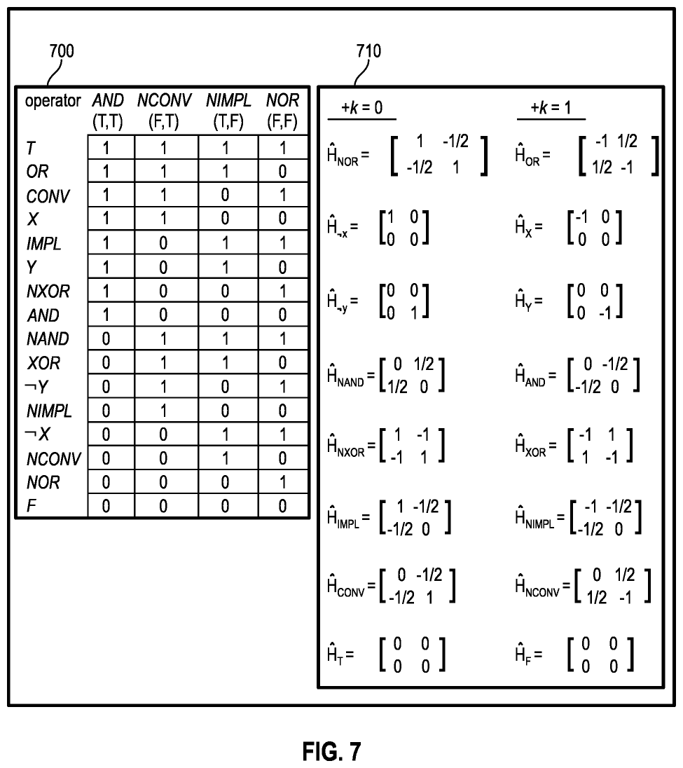

The component instruction set for this invention consists of three classes of operations. Relation operations check their input for the presence of specific atomic or composited relations (as described using Hamiltonians in the following sections). Reduction operations are designed to combine results from multiple relation operations into a single integer. Other operations assist in the implementation of sub-tasks within the architecture. For example, a so-called NO-OP passes the input as the output, unmodified. Such an operation can be used in combination with connectivity patterns to form delay circuitry or temporary memory. An example instruction set is the following: (i) Relation operations; (ii) the 16 Hamiltonians presented in 710 of FIG. 7 (described further below); composited Hamiltonians (see below); (iv) reduction operations, including sum and argmin; and (v) other operations including NO-OP, bitwise NOT and change connectivity: remove destination x, add destination y.

A primary purpose of this instruction set is to build knowledge of relations into the network of components. Together with a math of Hamiltonians (described further below), this instruction set creates a full language capable of expressing an entire symbol system (and any possible symbol) as a composited combination of its instructions. The result is a set of representations that can express relations, and are explainable.

Below is described multiple atomic instructions being composited into a single larger instruction. This larger instruction may be considered a single higher-order symbol (by comparison with symbol systems). This is bottom-up building of a symbol system from logic. In the illustrative embodiment, symbols are implemented entirely using low-precision integer arithmetic. Since each component knows what inputs to expect, it can produce an output as soon as it receives all of those inputs—it does not necessarily in all embodiments require a clock. Additional specifics are presented in later sections.

### D. Use Case A: Nearest Neighbor Handwriting Image Classification Machine

The first, exemplary, use case, presented in part for its simplicity, is application code that performs one-nearest-neighbor search (300 in FIG. 3). This algorithm takes a set of vector inputs, each the pixel values of a bitmap image and each paired with a label (e.g, label class 1=“this is an image of a cat”). In this case, the input is assumed to be the binary pre-processed input from (203 in FIG. 2). First, in stage 0 (301 in FIG. 3) the algorithm (which herein comprises a non-transitory computer-readable medium of program instructions, and also herein termed a process, procedure, software, etc.) memorizes a set of training images. At test time, it (stage 2; 303 in FIG. 3) compares a test image with each training image, using a multivariate distance/similarity measure (stage 1; 302). Finally, (stage 3; 304) it selects the label of the one most similar training image, and assigns the testing image to that label. Define that there are N training images, each with exactly D pixels.

When this task is written as application code for a conventional CPU, stage 0 is performed by storing the training datapoints in memory. Stages 1, 2, and 3 are performed using a long sequence of load/operate/store instructions. This application code consumes N*D bits of memory. Stage A1 requires O(ND) operations. Stage 2 requires O(ND) operations. Stage 3 requires O(log(N)) operations. In a serial computer, the run time of this use case is O(ND).

The alternate k-d tree approach (See Ben 93) to nearest neighbor computation usefully trades increased storage space for improved run time. For simplicity, this description omits this approach from further discussions, but it should be noted throughout that this approach (and others) also provide advantages in this invention.

### E. Hamiltonian Network Encoding

This section describes a novel working system that is integral to the specially designed hardware embodiments. It uses bitwise arithmetic, sparse connectivity, and low-precision computations. It forms the foundation of this invention's bottom-up compositional symbolic logic network. It is described below how it enables supervised learning of explainable relational information without the use of error propagation.

We introduce the method via examples from the simple and well-studied MNIST dataset. A simple illustrative demonstration on a standard MNIST dataset achieves high recognition with profoundly low computational cost and very little training—as well as the aforementioned ability to directly explain the logic of its categorization behavior, and to pinpoint the detailed contents of any data that are incorrectly recognized. In the familiar context of handwritten digit recognition, standard benchmarks can be readily matched, but importantly beyond the simple recognition rates, these new formalisms are introduced for learning, for matching, and for representation. The method is radically low cost compared with standard approaches, yet as will be shown, it can build rich generative representations.

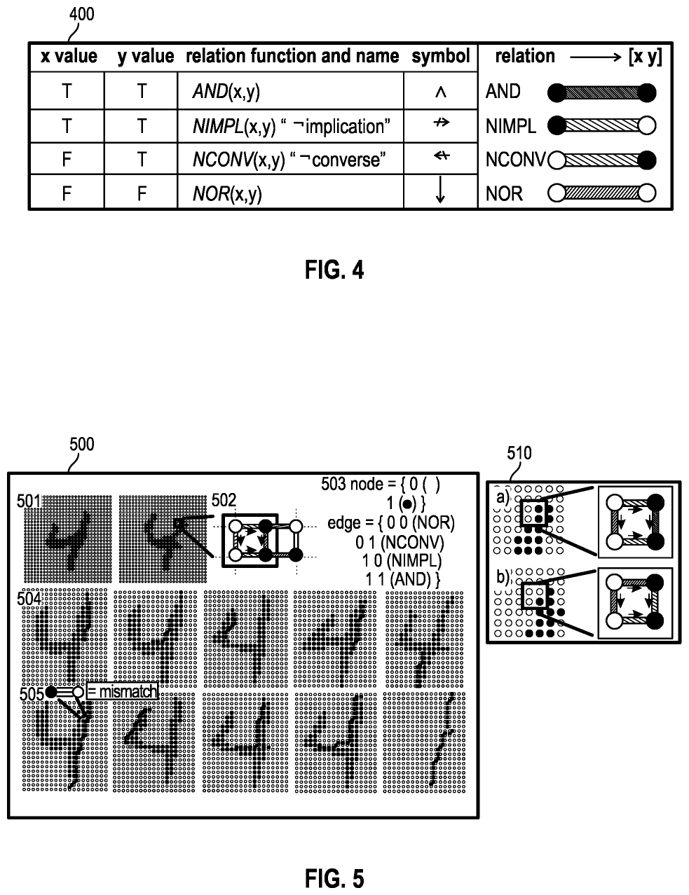

The resulting network performs multiple operations, including intrinsic construction of part-whole relations. As one illustrative special case of operation, the network performs supervised learning, yet uses no error correction mechanisms nor any non-local propagation (of the kind pervasive in multi-layer perceptrons such as deep learning). Notably, all calculations are parallel, local, and require only low precision computation, thus further conforming with several salient characteristics of brain circuitry. The following is a graph Hamiltonian conjecture: A neural unit combines its inputs, weights, and biases to approximate a polynomial response that can be directly rendered as a Hamiltonian operation on the inputs. The representations are graphs of binary nodes whose edges are pairs that simply denote the (directional) relation between neighboring nodes (respectively off-off, off-on, on-off, on-on; 400 in FIG. 4). The semantics of the edge relational information is used to learn part-whole representations, enabling recognition operations that respect the relations while maintaining the extremely low cost of binary bitwise arithmetic.

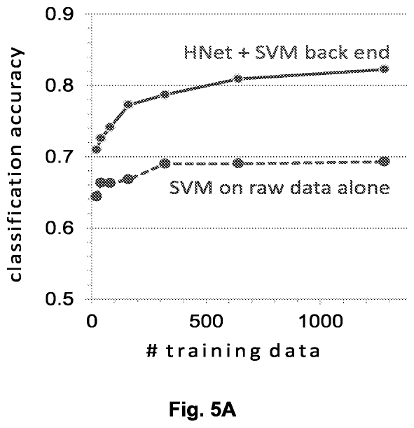

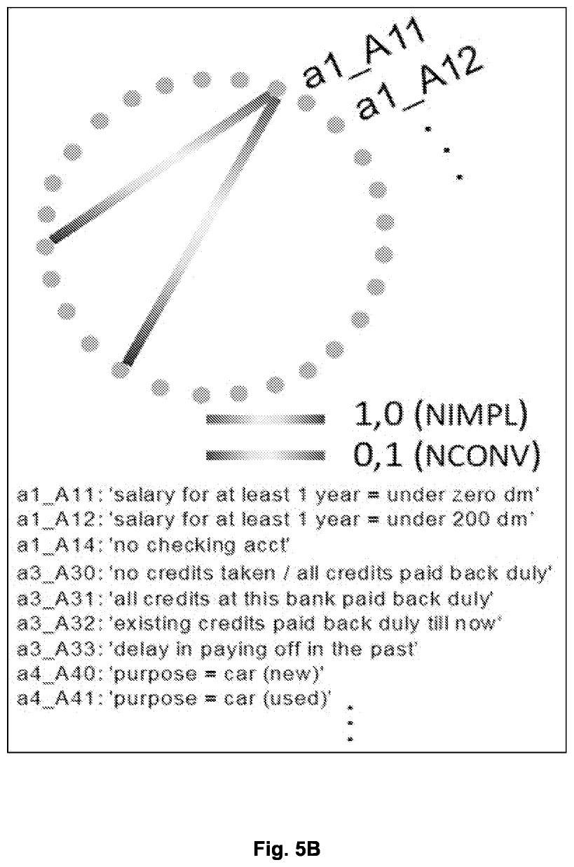

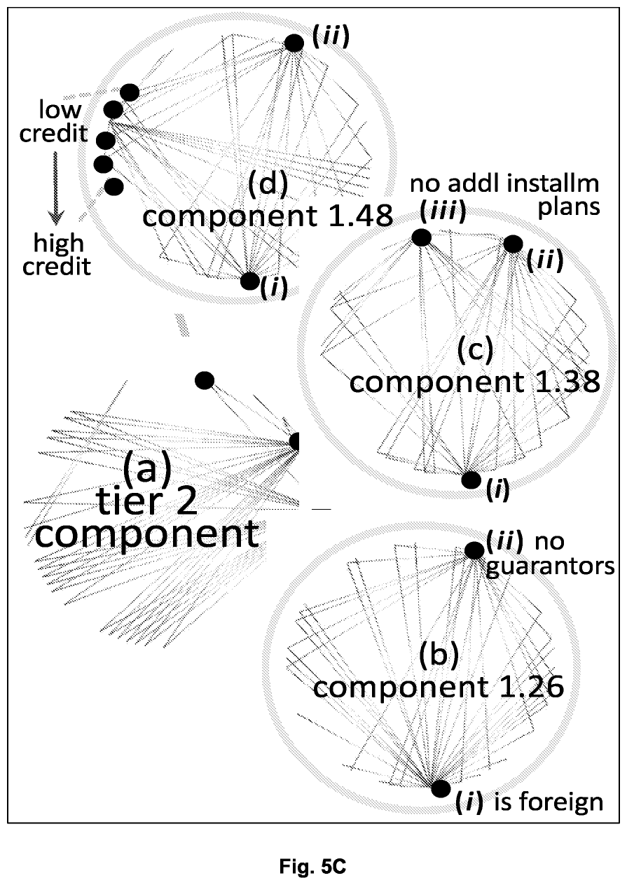

FIG. 5 shows examples 500 of a simple binary relational graph encoding. Block 501 shows sample MNIST images. In 502 and 503 a close-up of pixel encoding is shown: binary (black/white) pixels are connected as per directional convention (arrows), by four types of edges (00;01;10;11), corresponding to the logical operations NOR; negative CONV; negative IMPL; AND. Sample parts 504 harvested from training images. Sample part matches (colors/shades 505) and mismatches (red/differently shaded surrounds): matching is via Hamiltonians (see below). Two slightly different pixel configurations 510 in instances of the same label are also shown.

Initial inputs (203 in FIG. 2) in this case are generated by pre-processing MNIST handwritten digits. First, the pre-processing step 202 binarizes the grayscale bitmap imagery. Next, using a graph of the adjacencies amongst pixels, pre-processing converts the bitmap to a representation in terms of the four possible binary relations among pairs of adjacent pixels in the grid. In this graph, each pixel is a node, and four types of edge may exist between adjacent pixels: the four binary relations 11, 10, 01, 00 400 in FIGS. 4 and 500 in FIG. 5). These four binary pairs can be interpreted as logic relations: TT, TF, FT, FF. A graph is instantiated for each image. An edge between pixels x and y is present if the binary relation tied to that edge is true for the image. In other words, if pixel pair (x,y) takes the value (0,1) in one image, the graph for this image will contain a 01 edge from x to y. For the MNIST digits used here, the HNet entries are relations between pixels in accordance with the directional pairwise convention shown in 502 of FIG. 5. Note, as used herein, the term “HNet” shall taken as an abbreviation for a Hamiltonian Compositional Logic Network, which is a computing architecture used to encode and/or analyze data inputs in accordance with the teachings of the system and method herein. Sample HNets for MNIST examples are the matrices of relations in 504 of FIG. 5.

With reference to FIG. 5A, a comparative classification accuracy of a simple Support Vector Machine (SVM) back end, with and without HNet processing. SVM achieves 69% accuracy on raw data; HNet with SVM back end achieves 83%, a 14% improvement, due solely to the additional representational richness added by the HNet.

Briefly, FIG. 5B shows a diagram of nontopographic data such as arbitrary abstract attribute-value pairs; examples include consumer credit applications, pricing data, etc. FIG. 5C shows a close-up of an exemplary credit application data structure.

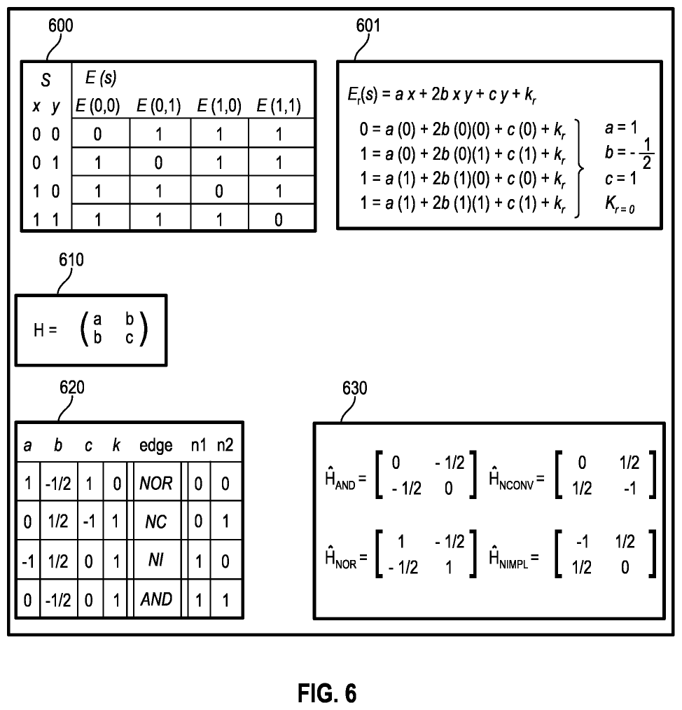

FIG. 6 shows energy values 600 E(s) for each of four possible states of binary pairs. Block 601 is a derivation of the values in 600. Visualization 610 of the meanings of positions a, b, and c within the 2×2 H matrix. Hamiltonian entries 620 are also shown. The entries 620 for the Hamiltonian representing each of the logical relations is given as the columns a, b, c, and k. The node assignments which satisfy a given relations are shown in columns “n1” and “n2”. Visualization of the four atomic Hamiltonian matrices 630 are shown as used in the illustrative embodiment.

For each of the supervised classes in the data (digits 0-9 for this MNIST dataset), training data is encoded as “HNets” for the labeled class (see Algorithm Ai below). Any arbitrary subportions of the image can be a ‘part’; in the examples presented here, parts are any continuous connected set of pixels. The encoded HNet for each such part is an upper-triangular matrix whose rows and columns are the dimensions of the inputs, and whose entries correspond to the image information relating each pair of locations in the given part. These data structures tend to be extremely sparse (mostly 0s).

Each stored HNet is intended for use in matching/recognizing a future novel (testing) datapoint. Applying a HNet to a new test datum yields an energy value E that is best when lowest (ideally 0). Energy is defined via application of a Hamiltonian to specified daa. The formula to calculate the energy (E) based on a vector of node activations [symbol] and a graph where the relations between nodes are defined by the Hamiltonian (H) is given as: E= [symbol] ^{T}·H· [symbol] +k. In other words:

$${E}_{r} = [ x y ] {\hat{H}}_{r} [ \begin{matrix}x \\ y\end{matrix} ] + {k}_{r} = [ x y ] [ \begin{matrix}a & b \\ b & c\end{matrix} ] [ \begin{matrix}x \\ y\end{matrix} ] + {k}_{r} .$$

where x and y are the binary data, as above; a, b, and c are the elements of the Hamiltonian, areal Hermitian symmetric matrix such that Ĥ_ᵣ∈ [symbol] ^{2×2}; and k_ᵣ is the energy constant associated with a given Ĥ_ᵣ such that E≥0. Thus:

$${E}_{\_ r} = a {x}^{⋀ 2} + 2 b x y + c {y}^{⋀ 2} + {k}_{\_ r}$$

and for binary data,

$${E}_{\_ r} = a x + 2 b x y + c y + {k}_{\_ r} .$$

For each of the four binary pairs, this equation can be simply solved for the three variables a, b, c to yield the unique Hamiltonian operator consistent with the specific pair (600 in FIG. 6).

For instance, for the state s in which x=0 and y=0 (the leftmost E(s) column in block 600), then thus determining the value of Ĥ__{NOR}. The values of the Hamiltonians for each of the four states are as shown below in 630. It is noteworthy that H operators conform with some intuitive and formal logical operations; for instance, negation (NOT) of a given H operator is achieved via multiplication by −1. Thus, NAND=NOT(AND) and Ĥ__{NAND}=−1Ĥ__{AND}. (Further relations of this kind are discussed in the next section.)

There are four functions that define the values a, b, c, and k. The specific mappings for these four function types are given in 620 (FIG. 6). There are sixteen possible such combinations of binary pairs. Four of these are the original binary pairs (400 in FIG. 4); the remainder are the set of arbitrary combinations of these four, as listed in 700 (FIG. 7). More particularly, FIG. 7 shows logical operators 700, in terms of the four fundamental operators AND, NCONV, NIMPL, and NOR. Hamiltonians 710 for all 16 operators are also shown. After training (steps detailed in Algorithm Ai), representations may come to have edges of any of the sixteen types listed here. If two adjacent graph nodes can each be either 1 or 0, but co-occur, such that the edge can be either 1,1 or 0,0 (700), it composes the binary combination of AND and NOR. Similarly, any occurring combination of pairs that occur in data can contribute to the composition of a given edge as any of the sixteen possible combinations. In the instance depicted in 510 (FIG. 5), the rightmost edge corresponds to 1010 (Ĥ__{IMPL}).

Using the same methods as in earlier paragraphs, the Hamiltonians for all sixteen operators are readily derived; they are listed in 710 (FIG. 7).

### F. Composing Hamiltonians

Each component implements one H (per version of application code). This may be one of the four fundamental matrices given in 630 (FIG. 6), or it may be a composite of multiple fundamental matrices. Composing Hamiltonians enables the construction of any symbol from these minimal operators.

Composing Hamiltonians enables explainable AI. Hence, starting from Hamiltonians of simple pairs of two unit inputs (e.g, pixels), one can construct any n-dimensional composite Hamiltonian matrix for a graph of arbitrary size, by projecting each of its individual values (corresponding to single edges) into the 2-dimensional subspace indicated by the variables involved in a given pairwise relation. The resulting n-dimensional composite Hamiltonian is then:

$${\hat{H}}_{\_ composite} = {\sum }_{( u , v , r ) ∈ R} ( {P}_{\_ uv}^{T} \cdot {H}_{\_ uvr} \cdot {P}_{\_ uv} + {k}_{\_ r} ) .$$

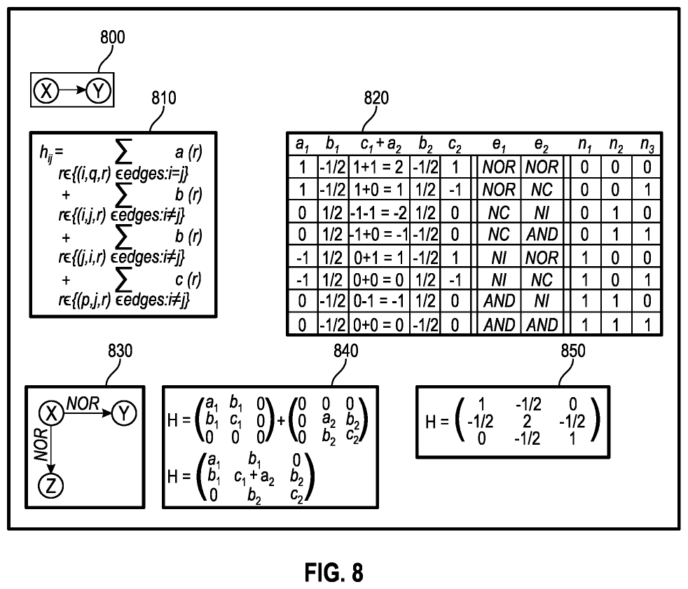

In the simplest possible case of a graph with two nodes and one edge 800 in FIG. 8), the Hamiltonian matrix (H) takes the form in 610 (FIG. 6), where the possible values for the H and k are given in 620 and depend on the particular logical relations between two nodes.

FIG. 8 shows the simplest possible HNet graph 800, with two nodes (pixels) and one edge. (810) Equations for constructing a composite H, one element at a time. The composite Hamiltonians 820 used in this section are also shown, in addition to a second example HNet graph, with two edges 830. FIG. 8 further depicts possible values for Hamiltonian matrix elements in the case of all possible consistent logical relation pairs 840, and an equation 850 resultant from evaluating (step 840) with the values in 820.

Hamiltonians for graphs with multiple edges are composed by adding the simple Hamiltonians for each edge relation. Edges are defined by a relation between node i and node j where i<j. This is shown in the following equation where r maps to indices to a relation type: r(i, j): N×N→{NOR,NC,NI,AND}. There are four functions that defines the values a, b, c, and k as described in 620 (FIG. 6) that are used in the construction of a composite Hamiltonian.

A LogicNet (or H-net) graph (the two terms can be used interchangeably) is a set of tuples defining the i and j nodes that are connected as well as the relation type that connects those nodes: edges={(i,j,r): i<j, r(i,j)}. Given this set of edges, one can then construct a composite H using the equation provided in block 810 (FIG. 8).

For any vector of binary assignments of node values, there exists a unique LogicNet composite Hamiltonian. As block 820 shows, for every consistent logical relation pair, there is a unique set of Hamiltonian matrix elements. Given this, one may conclude that there is a one-to-one mapping between the set of binary node assignments and their corresponding representation as a LogicNet Hamiltonian.

For example, in a graph with three nodes and two edges with NOR relations (O-NOR-O-NOR-O; block 830 in FIG. 8), the H presented is obtained in block 840 (the subscripts below indicate which edge the a, b, and c are associated with). Since a_₁, b_₁, c_₁, a_₂, b_₂, and c_₂, are all functions of r and r is NOR since that is the only relation, it yields the H in block 850 from the NOR entries in 620 (FIG. 6).

There exists a one-to-one mapping of H matrix elements to node value assignments. Since there are only two possibilities for a graph: 1) that all relations are consistent with each other and 2) that some relations are inconsistent. An example of inconsistency would be a graph with two connected nodes with the edges as O-AND-O-NOR-O. In this case, it impossible to satisfy both edge relations simultaneously by choosing binary assignments to the nodes. In order to satisfy the AND relation the process assigns (1,1) as the values for the first two nodes. However, that means the third node must either have the value 0 or 1. With either choice of assignment, the NOR relation will not be satisfied. Given this, the process is left with the possible consistent relation pairs in block 820 (FIG. 8).

The Hamiltonians can be fully reversible as long as the initial Hamiltonians are the 4 fundamental operators, even the composited ones. Thus, the representation is not lossy. Notable, this characteristic renders HNets highly explainable. As long as the atomic Hamiltonians are the four operators in 630 (FIG. 6), the composite Hamiltonians can be decomposed into their constituent parts for analysis. To understand the constituents of a high-level symbol, the composite Hamiltonians can be inverted to discover definitions of the lower-level symbols that make it up, described in terms of the input. For example, if a dataset for bank credit applications has been learned, some of the composite parts that may be learned include (unsupervised) categories such as wealth (which may correspond to combinations of zip code, mortgage amount, make of car); education (zip code, age at first job); etc.

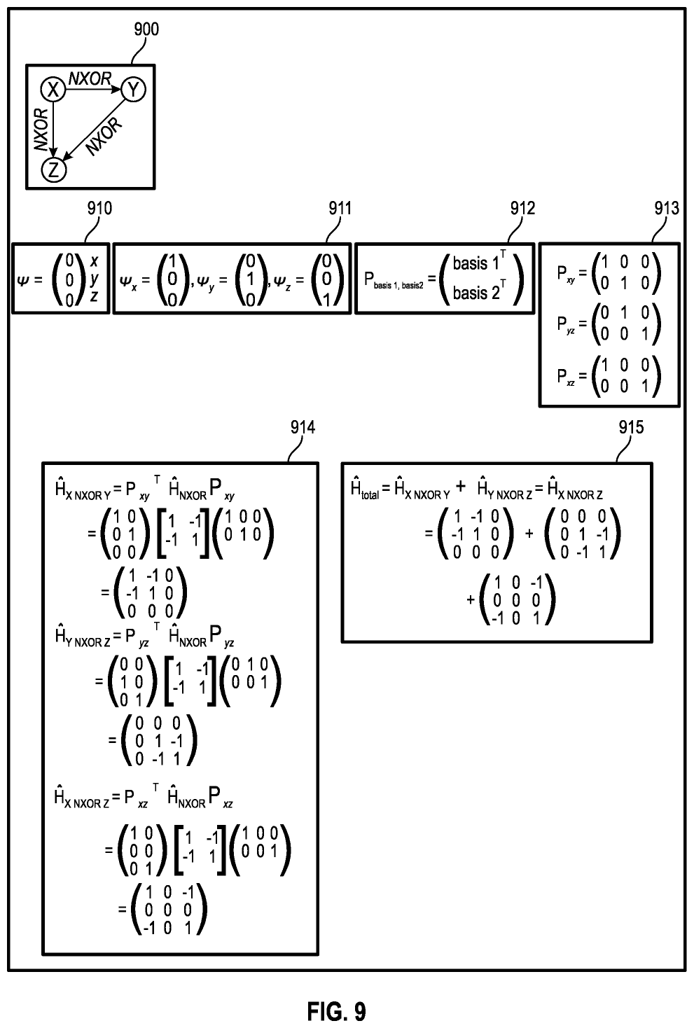

The method extends to enable construction of Hamiltonians for any arbitrarily sized graph. FIG. 9 shows simple graph 900 denoting three learned nodes and edges, to illustrate composing the Hamiltonians of XY, XZ, and YZ into a single Hamiltonian for XYZ. The three projection operators for the example in 900. More particularly, the simple three-node graph 900 is used herein to demonstrate how to compose the pairwise edges in a graph into a Hamiltonian for the entire graph, incorporating all its edges. The edges XY, YZ, XZ, each have an associated relation, either input or learned, as described in previous sections; that relation is one of the sixteen possible combinatory relations in 700 (FIG. 7). One can assume that each edge has the relation XNOR. The state vector for the problem is presented in block 910 (FIG. 9) such that the basis vectors are presented in block 911.

A projection operator is constructed, placing each 2×2 Hamiltonian operator matrix into the subspace of the larger 3×3 Hamiltonian (block 912 in FIG. 9) so that from these basis vectors, the process yields the following projection operators for the subspaces of the composite Hamiltonian (block 913). To project the H__{NXOR} operator onto the subspace spanned by the x and y dimensions, the process constructs the H_ₜₒₜₐₗ Hamiltonian as presented in block 914. The total/composite Hamiltonian is then obtained via summation of these three projected pairwise Hamiltonians (block 915).

Overall, this embodiment characterizes a system that provides on one hand, the simplicity and mathematical tractability of ANNs, and on the other hand, the richness of relations, part-whole, and compostability that are useful characteristics of symbol systems. The encoding of relations via Hamiltonians enables symbol-based relations to be encoded and composited with straightforward arithmetic operations.

### G. Algorithm Ai: Simple Approach to Use Case A

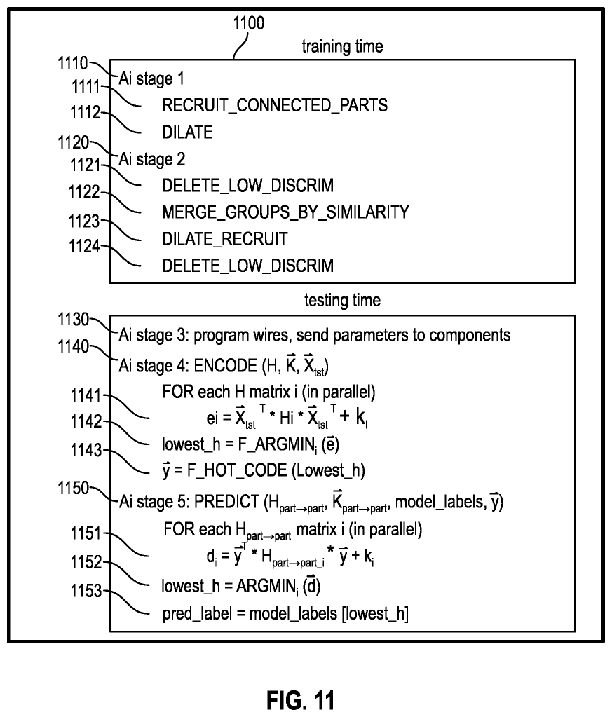

A straightforward approach to use case A is now described. Algorithm Ai is depicted in the pseudocode listing 1100. The training operation entails the below steps:
1. Ai stage 1: construction of initial components (1110 in FIG. 11)
   (a) Generate Hamiltonian logic network (HNet) matrices for all input component parts.
   (b) RECRUIT_CONNECTED_PARTS (1111).
   (c) DILATE (1112).
2. Ai stage 2: refinement of components using discriminative cues 1120)
   (a) DELETE_LOW_DISCRIM=Delete low-discriminability foveated components (1121).
   (b) MERGE_GROUPS_BY_SIMILARITY (1122).
   (c) DILATE_RECRUIT (1123).
   (d) DELETE_LOW_DISCRIM (1124).
3. Store HNets for all applied symmetries (1000).

As in block 501 of FIG. 5, two inputs (digit “4”s) that are desired to be matched may nonetheless have some different node and edge values. A given edge in a learned graph representation may thus have a value that is not one of the four simple binary pairs. For instance, if one of the 4's had a 0,1 edge at a location where another matching 4 had a 1,1 edge, then the value of the initial node at this edge has occurred once as a 0 and once as a 1 (510 in FIG. 5): rightmost edge is either 1,1 (purple) or 0,1 (orange)).

Query which value should that pixel be in future instances of the digit 4—a 0 or a 1?A typical approach to answer such is to collect statistics and use the resulting weights to influence future matching or recognition. In the learning operation here, as described, integer counts are maintained of the occurrence of each edge type at a given location, but when these do not match, the representation may be logically altered. The new value of the edge may take on values beyond those of the four binary pairs, corresponding to combinations of those pairs.

In the present example, the rightmost edge (connecting the top right and bottom right pixels) can be either a value 01 or a value 11. This corresponds to a logic statement that the first node is indeterminate whereas the second node must be a 1.

The three test operations are:
1. Ai stage 3: startup (1130 in FIG. 11)
   (a) Initialize connections with connectivity as required to provide the right pixels to the each component's Hamiltonians. Initialize without recurrence.
   (b) Initialize components to implement the learned Hamiltonians.
2. Ai stage 4: ENCODE (1140)
   (a) Measure the energy of the test image, separately using each Hamiltonian in the learned model, via the equation specified in the previous section and in 1141 (FIG. 11).
   (b) F_ARGMIN: Find the indices of the test image's F lowest-energy Hamiltonians, “lowest h” (1142).
   (c) F_HOT_CODE: Convert the resultant indices into an F-hot code. This code is an array of length equal to the number of components, with zeros in every element except those indexed by lowest h (1143).
3. Ai stage 5: PREDICT (1150)
   (a) Measure the pairwise distance between the test image and each training image, in the space of these F-hot codes (1151). Use energies as this distance measure.
   (b) Find the one lowest-energy HNet when applied to test image (1152).
   (c) Classify the testing image by assigning it the same label as the lowest-energy HNet (1153).

New inputs are tested for their energy values against the HNets that correspond to members of existing categories, by applying the Hamiltonians of each learned representation to the new input, such that the recognized category C is the one whose Hamiltonian H c produces the lowest energy for this input [symbol] : C=argmin__{C}( [symbol] ^{T}Ĥ__{C X} [symbol] ).

Define A:=average number of edges per pixel. B:=number of components. If the number of components B exceeds the number of pixels D, then testing time processing time complexity is O(A). Otherwise, the time complexity is O(A(D/B)). Due to parallelism, time complexity is a function of the number of training images N in neither case (unless the training algorithm selects a number of components B that is a function of N). In order to achieve these low time costs, this invention sacrifices high space costs. These space costs will be exemplified in the following paragraphs, the description herein explains specific hardware embodiments below.

To compute the degree to which classes can be discriminated by a particular component i (discriminability), the process first calculates a class histogram. This histogram is simply an array of length n_classes. Element j contains the frequency with which component i was found in training images of class j. The frequencies are normalized to the range {0,1}. Discriminability is calculated from this histogram by segmenting classes into those that are <0.5 (“classes to which component i does not respond”) and those that are >0.5 (“classes to which component i responds”). The discriminability is a function of this histogram that can be calculated: discriminability=2 [MEAN(hist ∀ hist≥0.5)−MEAN(hist ∀ hist<0.5)−0.5].

### H. Testing-Time Hamiltonians in Custom Hardware

An embodiment is now described of the testing-time portion of algorithm Ai in digital electronic hardware specially designed for the task in an optimally simple and parallel manner. For concrete numbers, the process assumes a dataset of N=20,000 datapoints, each with dimensionality D=10,000, as provided by the input code register 203 (FIG. 2).

In its most literal form, an atomic (non-composite) Hamiltonian uses 6 MULTIPLY gates and 4 ADD gates when measuring the energy of an edge. The configuration of these logic gates is consistent across time, so they can be statically wired in hardware. There are only sixteen possible atomic learned Hamiltonians, so these Hamiltonians can be provided as input from component-local read-only memory (ROM). This leaves eight inputs; the two bits that describe the edge (in a consistent/ordered/labeled-line format), and a four bit index that describes which Hamiltonian in ROM to use.

It is not always advantageous to assign each component to exactly one atomic Hamiltonian. Often, it is beneficial to assign a composite Hamiltonian to a component. Such Hamiltonians are now too myriad to enumerate in ROM. Beneficially, as composite Hamiltonians grow in size, their sparsity increases. So, instead of storing the entire composite Hamiltonian, the process stores only the nonzero values (along with their locations in the Hamiltonian matrix). These values can be stored in registers for small composites, or component-local DRAM for larger composites. The hardware for a single component may now possess many energy operators, operating partially in parallel, to avoid a prolonged execution time.

When working with composite Hamiltonians, algorithm Ai stage 4 1141 (FIG. 11) (the measurement of energy) can be implemented with two component banks operating in sequence. In the first step of algorithm Ai stage 4 (1141), each component is assigned one or more pixels of a single training image (Ai stage 3) 1130. The value of each pixel in each training image is separately compared with the value of the pixel at the corresponding location of the test image. This requires N*D parallel components (20,000*10,000=200M). Each of these components requires only one timestep to compute their result. The result is N*D scalars, each containing a pairwise comparison. Next, these pixel-wise comparisons are accumulated into N different sums (1141). Again, the programmable wiring achieves the routing of pixel-wise comparisons to their appropriate accumulators. Each of the N parallel accumulators need only sum whatever inputs are provided, without consideration for their source. The accumulators take no parameters, so they require 0 bit memory to store the model. Assuming that each accumulator will be implemented as a tree of small accumulators (with full parallelism within a level of the tree), all components require at least log(D) timesteps latency (log(10,000)=4). Both of these component banks can be fully pipelined, eliminating latency concerns.

The algorithm Ai functions F_ARGMIN (1142 in FIG. 11) and F_HOT_CODE (1143) are implemented together, as a unified F-winners-take-all component bank. The N energies from the accumulators form the input. Several valuable embodiments can produce the desired one-hot code. Embodiment (a) forms an array of N comparator components. Over time, the programmable wiring presents each comparator with the energy-index tuple for all of the N−1 other possible winners. Each comparator maintains a log_₂(F) bit count of how many inputs possessed lower energy. If the count reaches F, the comparator stops counting, ignores all further inputs, and returns a 0 when inputs stop arriving. Otherwise, when inputs stop arriving, it returns a 1. Embodiment (a) is not pipelineable, leading us to favor the next embodiment. Embodiment (b) uses another hierarchical tree arrangement of components. Each component is a comparator, taking energy-index tuples, and returning the energy-index tuple of the lowest energy input. After the tree has narrowed the list of tuples down to length F, an F-hot code is created by sending 1's to the appropriate indices of an all-zeros buffer, using the programmable wiring framework. The latency of this unified F-winners-take-all component bank is at least log(N)+F steps (again, one step if pipelined).

The hardware for finding the nearest training image to the test image (algorithm Ai stage 5 “PREDICT” (1150 in FIG. 11) requires surprisingly similar hardware to that just described for coding (stage 4 “ENCODE” 1140). In

FIG. 11, step 1151, two more banks of components collaborate to compute the energy of the test code with each part-part Hamiltonian. In step 1152, the winner-take-all hardware is replicated, this time with one winner instead of F winners, and no need to form a binary code from the winner's index. At the end, the lowest-Hamiltonian training image must be used to look up a stored label (step 1153). This is the simplest element to embody, since it is a single table lookup. For the simplicity of this embodiment, the index of the winning training image, lowest h, is returned directly to a co-processor as a uint16, which possesses a label lookup table in von Neumann memory.

It is relevant to note that all operations described above were pipelineable, potentially drastically increasing throughput buoying energy efficiency through waste avoidance. The presented architecture functions very differently from a conventional CPU. The vast majority of “programming” is mechanized by the parameters supplied to the so-called “programmable wiring”. In the coming paragraphs, the process describes this connectivity protocol and discuss some of the trade-offs considered during development.

The connective wiring is programmed during the “startup” stage of any algorithm (in algorithm Ai, this is stage 3; 1130 in FIG. 11). The network is programmed by setting a number of gated flip-flop circuits, partially in parallel and partially in serial. Each wire is one-to-many. For a given source (e.g, one bit from the input code register 203 in FIG. 2), a set of gated flip-flops work as a team to list a small set of destination indices. In this network, each index is hard-coded by the wiring diagram to map to one component or register. These flip-flop-driven indices in turn drive a topology of routing transistors to open or close, connecting certain inputs to certain outputs. The flip-flop memory requirements are on the order of billions of bits (highly variable based on task and problem size). In effect, the “programmable wiring” network is a large, distributed lookup table of routing information. As an illustrative example, a gated D latch (a known type of flip-flop) requires 1 NOT gate, 2 AND gates, and 2 NOR gates (though more transistor-efficient implementations are available).

During startup, a long string of routing parameters are passed through the network, over startup-specific, special-purpose logic. However, this logic can be wasteful overhead during any time but startup. Therefore, messages are sent over the data wires themselves. These messages are interpreted differently by the flip-flops when the network is in startup mode. The parameter messages follow strict formatting. The message sender (a compiler or driver framework, depending on use case) is expected to have full knowledge of the hardware connectivity, and tailor the streams of routing parameters in order to achieve the desired pathways. To aid in this effort, the connectivity is formed from repeated patterns and fractal hierarchies. Only after the programmable wiring is fully programmed do components receive their parameters. For simplicity and efficiency, component parameters follow the data flow pathways when possible. The startup operation requires a great many timesteps latency. It is comparable to starting up a conventional computer. However, like a conventional CPU startup sequence, much of the burden is a one-time cost.

In the simplest working example, each component would require >N*D=200M input wires in order to programmatically connect to any combination of other components without delay or interference. This is untenable. Instead, each component can be parametrically connected to only a small fraction of other components. For any given task, only a small fraction of those components can be simultaneously connected. Instead, most are disconnected: Most possible inputs have been denied a path to the destination component by the flip-flop controlled transistors. The connectivity amongst components is designed such that they can support as broad a variety of connectivity profiles, and therefore as wide an array of tasks, as possible. A core benefit to this invention is that it relies on sparse (few) connections and sparse (rare) communication, an example of which has just been described. Sparse connections mean that one can place hubs in the connectivity profile without introducing bottlenecks. This reduces the number of physical wires. Sparse communication means that the consumed bandwidth is a miniscule fraction of what it could be (reducing bandwidth requirements for the illustrative design commensurately).

The number of wires in such an implementation can still be considered large. In fact, the process calculates that the programmable wiring will form the vast bulk of die space and complexity. Because communication messages contain so few bits, it's reasonable to have just one or two wires per connection with minimal impact on latency. If the components are sorted by implementing connected part Hamiltonians (1141 in FIG. 11) by input, it can create a reduced indexing space for each source and thus drastically reduce requirements for routing hardware. However, these components can be sorted by input or by output, not by both. In cases of recurrence, the best sorting is task-specific.

As the scale of the exemplary models increases, so does the number of transistors. Therefore, the programmable wires are designed to effectively interconnect multiple integrated circuits. Several properties aid this. Firstly, the implementation uses serial communication to reduce the number of physical wires that must pass between integrated circuits. Secondly, the massive parallelism in the architecture means that it can accept slow baud rates. Thirdly, the extreme sparsity of connections amongst components extends to connections amongst integrated circuits. Finally, variable bit-length signals are applied, and the implementation reuses the physical wires amongst integrated circuits for multiple logical wires to improve throughput.

If recurrence is desired (out of scope for use case A), each (e.g, uint8) signal would be converted into a one-hot code and placed in the pre-processed input register (203 in FIG. 2). The programmable wires can then shuffle them to the right destination alongside external inputs.

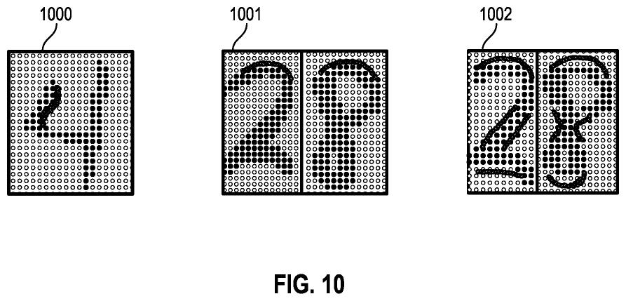

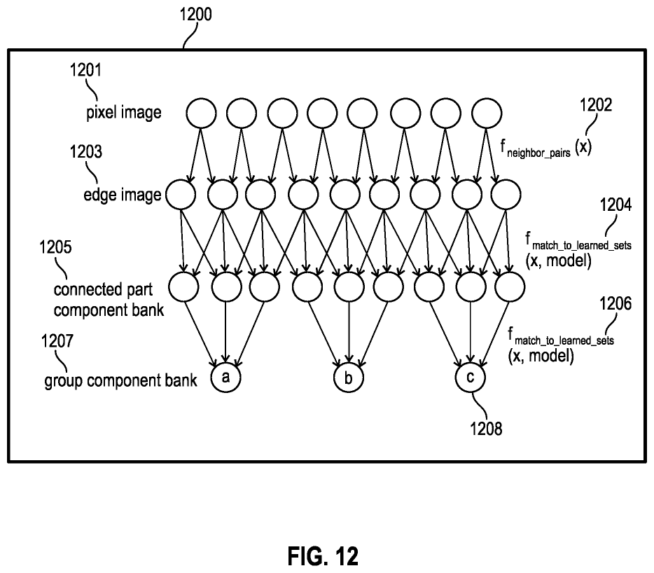

FIG. 12 contains an alternate depiction 1200 of algorithm Ai at testing time, described in terms of the hardware of data registers and data modification operations. For those of skill in the art of ANNs, this alternate depiction can appear somewhat familiar. Various embodiments can include an interface for communication with an analog system for certain computation. More particularly, FIG. 12 shows a hardware summary 1200 for an embodiment performing algorithm Ai at testing time. The pixel image contains an array of Boolean pixels 1201, and the mapping 1202 from block 1201 to 1203 is performed by f__{neighbor_pairs}. This function constructs an adjacency graph of the pixels, with four types of edge between each pair of adjacent pixels (00, 01, 10, 11), as described below. Edges present in the image are enumerated in the “edge image.” Connectivity is sparsely fan-in/fan-out. The edge image 1203 contains an array of values ranged {00,01,10,11}, stored as a Boolean vector. The mapping 1204 from block 1203 to 1205 is performed by f__{match_to_learned_sets}. This function performs a separate calculation for every connected part component i. Taking those edges that are nonzero in the composite Hamiltonian for connected part component i, it computes the similarity between the edge image and the connected part component, as energy. This energy value is sent to block 1205. Connectivity is again fan-in/fan-out, with slightly reduced sparsity. The encoding 1205 of the connected part component bank contains an array of integers ranged {0,127}. Each value i represents the similarity between the input image and connected part component i, measured as the energy of the composite Hamiltonian corresponding to connected part component i. The mapping 1206 from block 1205 to block 1207 is then performed by another call to f__{match_to_learned_sets}. This function operates similarly or identically to that of block 1204, but measures the similarity of the connected part component code to the learned group j. Because there are few group components, this step greatly reduces the dimensionality of the data. The group component bank encoding 1207 contains an array of integers ranged {0,127}. A single element of the group component bank encoding 1208 can represent the degree to which a set of similar connected part components. For example, the top-most component 1002 in FIG. 10 can be found in the image.

### I. Testing-Time Hamiltonians as a Boolean ANN

The HNet described in the previous paragraphs provide a novel mechanism for building, storing, and using relations. Conveniently, the foundation of the HNet is Boolean logic—the atomic Hamiltonians implement Boolean operators. This suggests an alternate approach to the testing time embodiment that may be more efficient and hardware friendly.

Instead of utilizing an atomic Hamiltonian directly, the four edges are converted from 2-bit vectors (400 in FIG. 4) to 4-bit one-hot codes (drawn from the set {0001,0010,0100,1000}). Next, with the input edge in this new format, the process measures its dot product with the input vector for which Hamiltonian i would produce the minimal energy (0). When ranking the input edge based on its similarity to each learned Hamiltonian, it is found that the Hamiltonian with the maximal dot product is the Hamiltonian with the minimal energy.

Since the dot product is operating on Boolean vectors, it can be implemented as the sum of a bitwise AND, which costs 2 AND gates and 1 ADD gate (vs 6 MULTIPLY and 4 ADD for the atomic Hamiltonians). The illustrative embodiment maintains two versions of the trained network for any task. Composite Hamiltonians are used for theory, explainability, and as a mechanism for learning. For testing time operations, or for closest comparison against ANNs, the process compiles the Hamiltonians down into a Boolean dot product machine.

### 1. Correspondences Among Systems

The relation between a HNet's Hamiltonian computations, and those of standard current linear-algebra-based ANN systems is now discussed. The following two tables describe analyses of simple examples both in terms of Hamiltonians and of standard ANN vectors.

TABLE 1
${\hat{H}}_{AND} = [ \begin{matrix}0 & - 1 / 2 \\ - 1 / 2 & 0\end{matrix} ]$
${\hat{H}}_{NCONV} = [ \begin{matrix}0 & 1 / 2 \\ 1 / 2 & - 1\end{matrix} ]$
${\hat{H}}_{NOR} = [ \begin{matrix}1 & - 1 / 2 \\ - 1 / 2 & 1\end{matrix} ]$
${\hat{H}}_{NIMPL} = [ \begin{matrix}- 1 & 1 / 2 \\ 1 / 2 & 0\end{matrix} ]$

The above table shows the four unit edge types, their corresponding Hamiltonians and the a,b,c values that comprise them, and the corresponding higher-dimensional projection that would be used to operate on these edge types via ANN-like weight matrices. In the math of HNets, for a given edge, a Hamiltonian is stored (via the above Table 1), and energy may be calculated per the following equation:

$$E = {\overline{x}}^{T} \dot{H} \overline{x} + k$$

For that same edge, the computing process herein generates a projection into a four-dimensional (4D) space with a specific one-hot vector assigned for each given edge type as in the first two columns of the following Table 2:

TABLE 2

| edge | projection | a b c | Ĥ |
|---|---|---|---|
| | 1 | | |
| 0 0 | 0 0 0 | 1 −½ 1 | $( \begin{matrix}1 & - 1 / 2 \\ - 1 / 2 & 1\end{matrix} )$ |
| | 0 | | |
| 0 1 | 1 0 0 | 0 1/2 −1 | $( \begin{matrix}0 & 1 / 2 \\ 1 / 2 & - 1\end{matrix} )$ |
| | 0 | | |
| 1 0 | 0 1 0 | −1 1/2 0 | $( \begin{matrix}- 1 & 1 / 2 \\ 1 / 2 & 0\end{matrix} )$ |
| | 0 | | |
| 1 1 | 0 0 1 | 0 −1/2 0 | $( \begin{matrix}0 & - 1 / 2 \\ - 1 / 2 & 0\end{matrix} )$ |

More particularly, the above table shows the relationship between Hamiltonians and ANN representations for the four unit edge types. (abc, H columns; right): For each edge, the values of a,b,c are defined for the corresponding Hamiltonian; (projection column; middle): For the same edges, the corresponding one-hot vector is shown, effectively projecting two-dimensional edge values into four dimensions, such that each dimension is dedicated to a specific edge type.

TABLE 3

| | Ĥ | composition |
|---|---|---|
| edge 1 1 0 | $( \begin{matrix}- 1 & 1 / 2 \\ 1 / 2 & 0\end{matrix} )$ | |
| | | [symbol] |
| edge 2 1 1 | $( \begin{matrix}0 & 1 / 2 \\ 1 / 2 & 0\end{matrix} )$ | |
| | projection | composition |
| edge 1 1 0 edge 2 1 1 | 0 0 1 0 0 0 0 1 | $\begin{matrix}\\ \{ \\ \{\end{matrix} ( \begin{matrix}0 \\ 0 \\ 1 \\ 0 \\ 0 \\ 0 \\ 0 \\ 1\end{matrix} )$ |

The above table shows compositionality in HNet and in a corresponding linear-algebra system. Whereas Hamiltonians for multiple edges are composed in a manner discussed above, the higher-dimensional one-hot projections of edge vectors are composed by the process, more particularly, by appending them, then projecting them into a higher dimensional space with unusual properties.

Unsupervised learning of the four-dimensional one-hot vector can then be performed by the process. A straightforward method can be employed in the process, based upon standard unsupervised “competitive” networks (Rumelhart & Zipser. 1986), by modifying the synapses of a target “winning” dendrite, changing their weights in a direction defined as the difference between the existing synaptic weight, and the value of the input itself (either a 1 or 0 in the four-dimensional “projection” vector from Table 2 here); i.e.,

$$Δ {w}_{i , j} = k ( {x}_{i} - {u}_{i , j} )$$

for a weight on the “winning” target cell in response to input vector \vec{x}. (Note that where the “learning rate” parameter k is 1, then the weight vector w̅ becomes equal to the input vector \vec{x}.) To “recognize” this stored memory, a standard weighted sum would be computed:

$$y = {\vec{w}}^{T} \vec{x} + const$$

For HNet processing of this same edge, a Hamiltonian can be generated for the edge, via Table 1 (above), and it would be recognized via an energy calculation as in equations 1-3 below:

$${E}_{r} = [ x y ] {\hat{H}}_{r} [ \begin{matrix}x \\ y\end{matrix} ] + {k}_{r} \qquad ( Eq . 1 )$$

$$= [ x y ] ( \begin{matrix}a & b \\ b & c\end{matrix} ) [ \begin{matrix}x \\ y\end{matrix} ] + {k}_{r}$$

or in quadratic form:

$$= {ax}^{2} + 2 bxy + {cy}^{2} + {k}_{r} \qquad ( Eq . 2 )$$

(and further simplified for binary values of x and y):

$$= ax + 2 bxy + cy + {k}_{r} \qquad ( Eq . 3 )$$

Treatment of composite edges entails further projection to higher dimensional spaces; e.g., for two edges, the composing of Hamiltonians can be generated by the process, as shown in the “Compositionality” section above, but for the corresponding linear-algebra operation, the two edges would be projected into a correspondingly higher-dimensional space as per Table 3, above.

In Table 1, above, two edges 1-0 and 1-1 are generated by the process, first into a composite Hamiltonian as per the compositionality methods described earlier. Note that employing the linear-algebra computation technique referenced above, the two edges would first be projected into four-dimensional space as just described and then the two 4D vectors (for the two edges) is, thus, composed by projection into an eight-dimensional space, consisting of the latter four dimensions appended to the initial four dimensions, such that every four-dimensional subspace is one-hot.

Note that the higher-dimensional Boolean weight-based version of these computations are mathematically equivalent to the Hamiltonian version. Thus, logical relations that can be computing by the process on Hamiltonians can be mapped directly to the weight-based method as projected to higher dimensions (see code listing in Table 4, below).

### Table 4 Equivalence of Energy Computation Via Ĥ or Via Dimensional Projections

The following extended pseudocode demonstrates the computation of the energy( ) function using Hamiltonians or using the projection of vectorized input into higher dimensions as described in section V in the main text (“Identification of equivalences”):

```
TABLE 4
G is the graph
n_cmp is the number of components (composite Hamiltonians)
compbankEdgeStates is G.n_edges x compbank.n_cmp (each element a 4-value
enumeration)
data is a set of node values (0 or 1)
edgeData is G.n_edges × 1 (each element a 4-value enumeration)
function energies = Energy(G, n_cmp, compbankEdgeStates, data, do_h_mode)
  energies = zeros(n_cmp × 1)
  if do_h_mode
    for i = {1 .. n_cmp}
      [H,k] = GenerateCompositeH(G, compbankEdgeStates(:,cmp), i)
      energies(i) = data′ * (H * data) + k
    energies = max(energies) − energies (convert from 0 = best to larger = better;
similarity)
  else
    edgeData = GetEdgeStates(data, G) (convert to edges)
    for i = {1 .. n_cmp}
      energies(i) = sum(compbankEdgeStates(:,i) == edgeData |
compbankEdgeStates(:,i) == NULL)
    energies = energies − min(energies)
function [H,k] = GenerateCompositeH(G, edgeStates, cmp)
  n_present_edges = sum(edgeStates ≠ NULL)
  rows = zeros(n_present_edges * 3 × 1);
  cols = zeros(n_present_edges * 3 × 1);
  vals = zeros(n_present_edges * 3 × 1);
  op = [1 −1 1 0 ;... (NOR)
    0 1 −1 1 ;... (NCONV)
    −1 1 0 1 ;... (NIMPL)
    0 −1 0 1]′ (AND)
  k = 0
  count = 0
  for r = {1 .. 4} (for each unit H type)
    mask = (edgeStates == r)
    n_new = sum(mask)
    edgeNodes = G.edgeEndnodeIdx(mask,:) (n_edges × 2; src and dst node)
    rows(count+(1:n_new)) = edgeNodes(:,1)
    cols(count+(1:n_new)) = edgeNodes(:,1)
    vals(count+(1:n_new)) = op(1,r) (implicit expansion)
    count = count + n_new
    rows(count+(1:n_new)) = edgeNodes(:,1)
    cols(count+(1:n_new)) = edgeNodes(:,2)
    vals(count+(1:n_new)) = op(2,r) (implicit expansion)
    count = count + n_new
    rows(count+(1:n_new)) = edgeNodes(:,2)
    cols(count+(1:n_new)) = edgeNodes(:,2)
    vals(count+(1:n_new)) = op(3,r) (implicit expansion)
    count = count + n_new
    k = k + op(4,r) * n_new
  H = sparse(rows, cols, vals, G.n_nodes, G.n_nodes)
function edgeStates = GetEdgeStates(data, G)
  temp = data(G.edgeEndnodeIdx(:,1)) .* 2 + data(G.edgeEndnodeIdx(:,2))
  edgeStates = zeros(G.n_edges × 1)
  edgeStates(temp == 0) = 1 (NOR)
  edgeStates(temp == 1) = 2 (NCONV)
  edgeStates(temp == 2) = 3 (NIMPL)
  edgeStates(temp == 3) = 4 (AND)
  edgeStates = FilterEdgeType(edgeStates, G.edgeTypeFilter)
```

In the weight-based architecture introduced here, inputs are represented by sparse activity in a relatively high dimensional space, with a specific and unusual set of constraints on representational design. Although this design is not typical of standard backprop or deep-backprop architectures, the design nonetheless can be seen to have points of correspondence with a rich literature in which high-dimensional vectors are intended to encode symbolic content, such that the resulting “symbols” may nonetheless then be operated on by numeric rules of the kinds used in ANNs. Key examples are embeddings, as initially in Word2vec, and then in BERT, GloVe, GPT-3, DALL-E, and several additional transformer models, which are of intensive current interest in ML and ANNs (Brown et al., 2020; Mikolov, Sutskever, Chen, Corrado, & Dean, 2013; Pennington, Socher. & Manning, 2014). In general, possible links of this kind, between symbolic and sub-symbolic representations, are the subject of very active ongoing research (see, e.g., (Garcez & Lamb. 2020: Ganther, Rinaldi, & Marelli, 2019; Holyoak, 2000; Holyoak, Ichien, & Lu, 2022; Kanerva, 2009; Smolensky, McCoy, Fernandez, Goldrick, & Gao, 2022)) and bear some resemblances with other, quite different, logic-based computational designs (see, e.g., Parsa, A., Wang, D., O'Hem, C., Shattuck, M., Kramer-Bottiglio, R., & Bongard, J. (2022). Evolving programmable computational metamaterials. Paper presented at the GECCO '22.

### 2. From Hierarchical Statistics to Abduced Symbols

It is contemplated that large-scale training, hierarchical constructs can be accreted as in large deep network systems, with the key difference that, in HNets, such constructs have relational properties beyond the “isa” (category) relation, as discussed above

Such relational representations lend themselves to abductive steps (See McDermott D (1987) A critique of pure reason. Comp. Intell 3:151-160; or “retroductive” (Pierce 1883)); i.e., inferential generalization steps that go beyond warranted statistical information. If John kissed Mary, Bill kissed Mary, and Hal kissed Mary, etc., then a novel category #X can be abduced such that #X kissed Marv.

Notably, the new entity #X is not a category based on the features of the members of the category, let alone the similarity of such features; i.e., it is not a statistical cluster in any usual sense. Rather, it is a “position-based category,” signifying entities that stand in a fixed relation with other entities. John, Bill, Hal may not resemble each other in any way, other than being entities that all kissed Mary. Position-based categories (PBCs) thus fundamentally differ from “isa” categories, which can be similarity-based (in unsupervised systems) or outcome-based (in supervised systems). PBCs share some characteristics with “embeddings” in transformer architectures.

Abducing a category of this kind often entails overgeneralization, and subsequent learning may require learned exceptions to the overgeneralization. (Verb past tenses typically are formed by appending “-ed”, and a language learner may initially overgeneralize to “runned” and “gived,” necessitating subsequent exception learning of “ran” and “gave”.)

Simple abductive steps are generated by the process herein as the HNet constructs hierarchies:

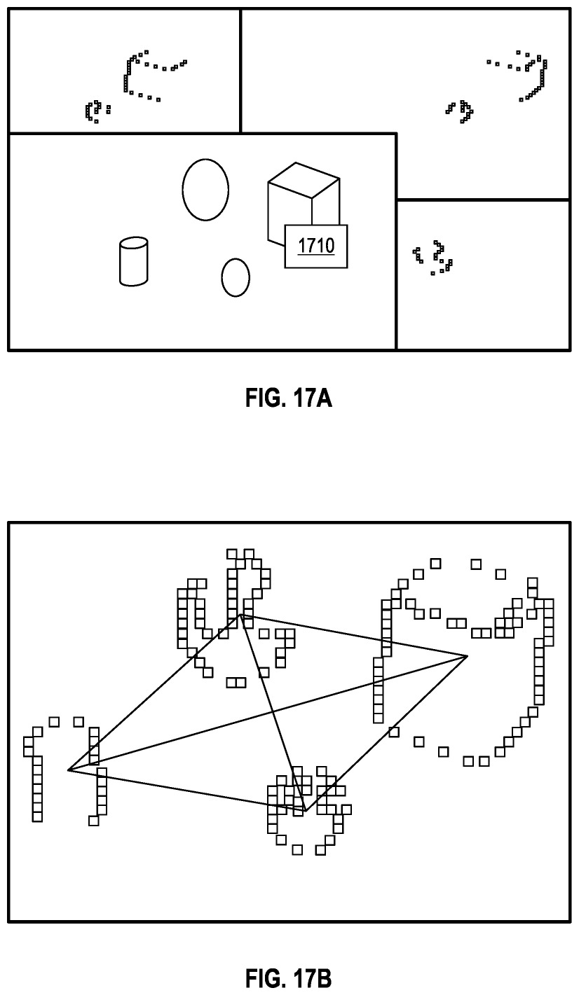

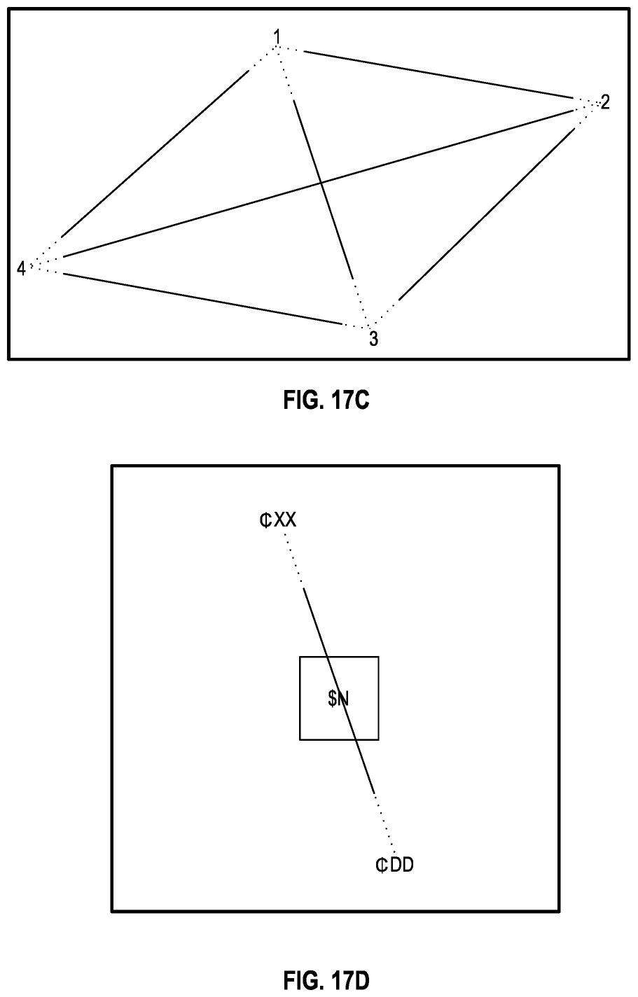

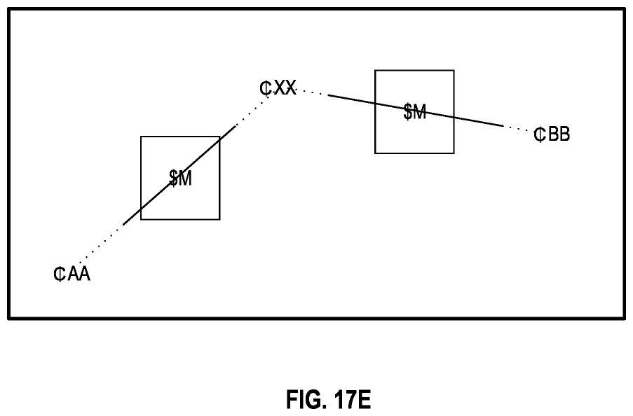

Successive epochs
i) Cluster together multiple similar Tier n+1 instances e.g., (LEFT x1 y1). (LEFT x2 y2). (LEFT x3,y3), . . . .
ii) Create Tier n+2 element that ORs the arguments of the Tier n+1 instances. e.g. (LEFT (OR x1 x2 x3) (OR y1 y2 y3))
iii) Abduce Tier n+3 (“type”) arguments (d,$) that overgeneralize from the Tier n+2 OR'd (“token”) arguments. e.g., ($LEFT ¢X ¢Y)
   Initial versions of these abductive methods have been implemented and applied to the CLEVR image dataset (Sampat S, Kumar A, Yang Y, Baral C (2021) CLEVR_HYP: A challenge dataset. Assoc Comp Ling, pp. 3692-3709). FIGS. 17A-17E illustrate simple instances of the resulting abduced entities, both objects (categories; #A) and sequential relations ($M), and compositions of these. More particularly, image features, shown in the inset 1710 of FIG. 17A, are rendered into individual entities in FIG. 17B, with initial individual relations shown in FIG. 17C. After repeatedly occurring as a statistical class, they are abduced, as shown in FIGS. 17D and 17E, to (possibly overgeneralized) position-based categories of objects (dXX, #DD) and sequential relations ($M, $N).

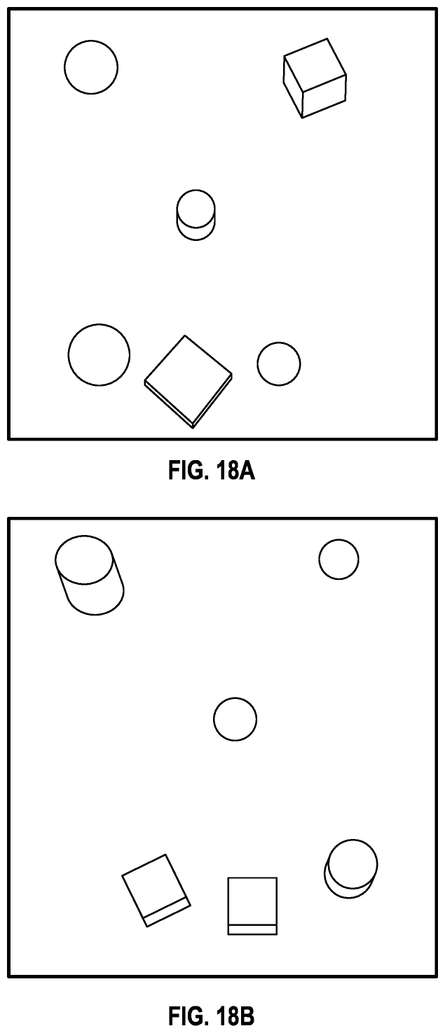

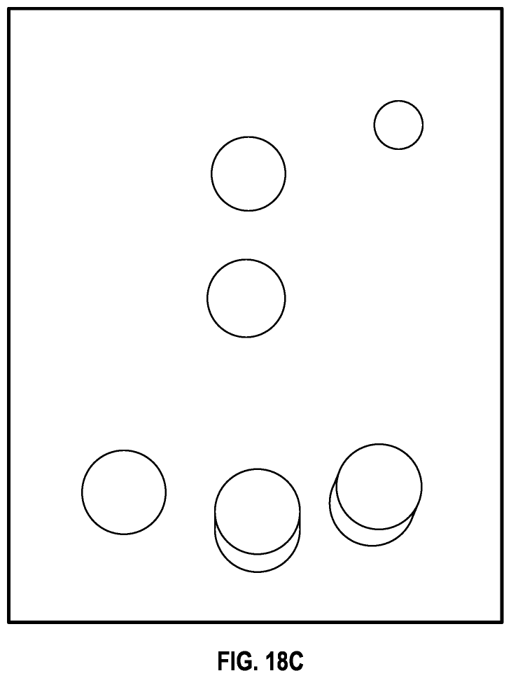

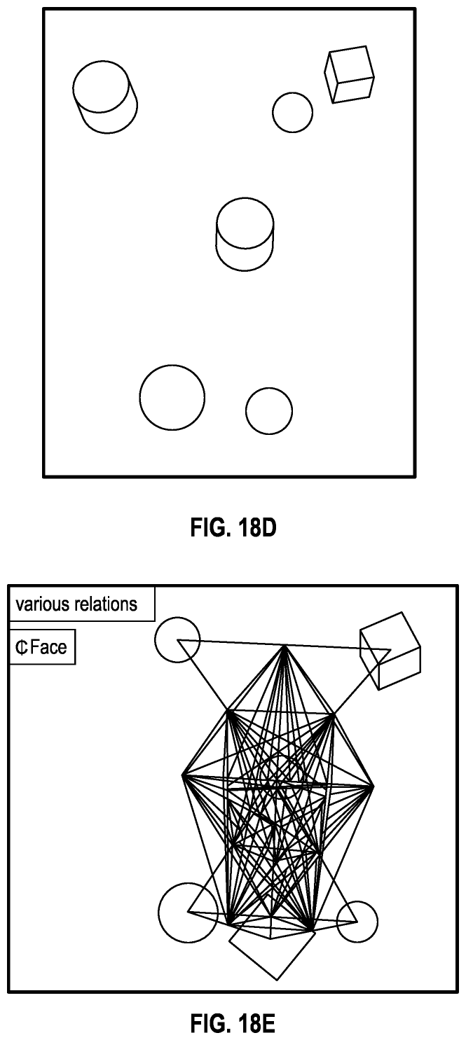

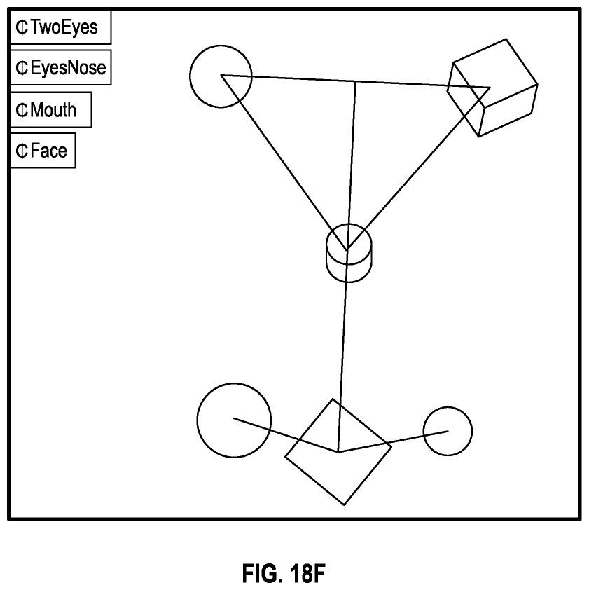

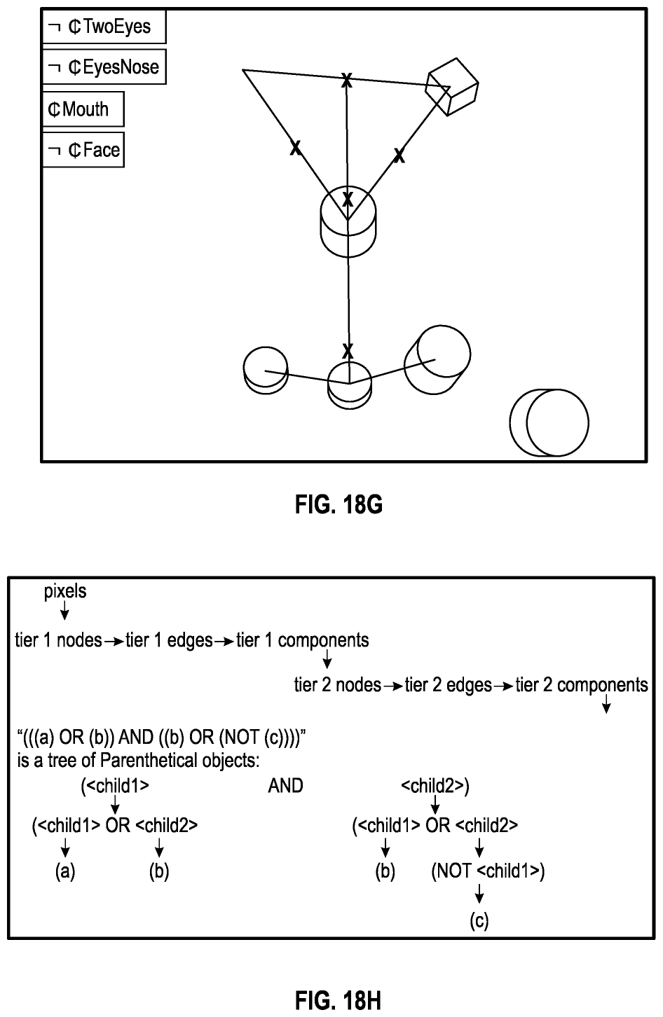

The ongoing hierarchical construction of such entities can enable increasingly “symbol-like” representations, arising from lower-level “statistic-like” representations. FIGS. 18A-18H illustrates construction of simple “face” configuration representations, from exemplars constructed within the above-referenced CLEVR system consisting of very simple eyes, nose, mouth features. Categories (¢) and sequential relations ($) exhibit full compositionality into sequential relations of categories of sequential relations, etc.; these define formal grammars (See Rodriguez & Granger 2016; Granger 2020 referenced below). Exemplars (FIGS. 18A and 18B) and near misses (FIGS. 18C and 18D) are presented, initially yielding just instances, which are then substantially reduced via abductive steps (FIG. 18H). More particularly, FIGS. 18A-18G show relations in instances and non-instances of “faces” in CLEVR. In addition to the examples (FIGS. 18A and 18B) and near-misses (FIGS. 18C and 18D), a statistical rendering of the class of faces comes to contain many individual links (FIG. 18E), which are greatly reduced via simple abductive steps to match (FIG. 18F) or fail to match (FIG. 18G) new instances. FIG. 18H shows examination/analysis of the configurations for shared regularities.

### 3. Alternate Encoding Function

The following table (Table 5) presents an alternate encoding function that can be employed by the system and method herein;

TABLE 5
Alternate encoding function

[symbol]

_{similarity} ← ENCODE_{similarity}(R, [symbol] ₜₛₜ, G) is: [symbol]
s∈ [symbol] nedges

| | |
|---|---|
| for i∈ {1 .. n_{edges}} | (convert activations to edge states) |

```
    sᵢ ← LOOKUP ((xₜₛₜ [G.edge_i_node_1], xₜₛₜ [G.edge_i_node_2]) (see Table 1)
  for i∈ {1 .. n_{cmp}}
    yᵢ← sum(R[:, i] == [symbol]   | R[:, i] == NULL).
```

### 4. Comparing Image Processing Networks

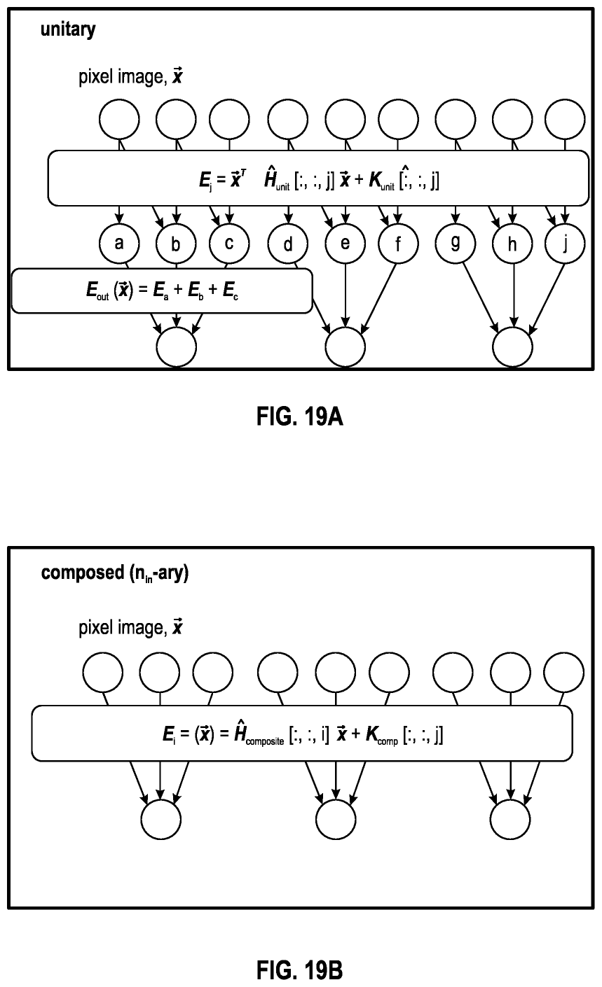

With brief reference to FIGS. 19A and 198, two respective image-processing networks are depicted, which produce identical results. FIG. 19A shows a HNet comprised exclusively of unit (single-edge) Hamiltonians and summation components. FIG. 19B shown a HNet comprised exclusively of composite Hamiltonians. All components perform the same operation.

### J. Word-Serial Processing

Instead of being sent one by one, messages are often packetized into groups called words. This is a common approach in prior art, because it comes with several advantages that become apparent when designing the hardware implementation. A word-serial embodiment is now described, which packetizes all data, communications, and arithmetic operations into 32 bit words. The optimal word size is dependent on many factors. Any math herein extends to other word sizes.

Word-serial processing has many well-known benefits. For example, the same amount of memory can be indexed with less indexing overhead. However, to avoid the waste associated with sending small messages in 32 bit packages, the sub-tasks must be arranged such that messages can be grouped. Due to the connective sparsity inherent to this invention, there are relatively few opportunities to group data into words. As mentioned earlier, the order of bits in the pre-processed input buffer 203 (FIG. 2) can be sorted, such that messages destined for the same destination are generally next to each other. In this case, these messages from the input buffer can be grouped into words.

Within a component, there exist greater opportunities for word-serial processing. For example, multiple pairwise ANDs can be performed together. Hamiltonians can be packetized for storage and retrieval. Within a component, the number of transistors need not be severely impacted by a word-serial architecture.

### K. Global Memory

An alternate embodiment contains sufficient global memory to store all training values. Thus, evaluating a testing datapoint involves loading a stream of composite Hamiltonians from memory, as operands. These composite Hamiltonians must arrive at the right component at the same time as all other operands. Such an approach greatly increases the strain on the programmable wires, potentially requiring a second connectivity protocol.

As an example, the MoSys BLAZAR BE3-BURST SRAM memory module (MoSys whitepaper) is chosen herein. At time of writing, this module contains >279 MB of memory capacity and costs approximately US $450. The memory module has a maximal bandwidth of 15*16=240 Gbps. This memory-based embodiment requires N* D bit (20,000*10.000=200M bit z 24 MB) of sequential-access memory. Therefore, if memory were the bottleneck, the architecture would take 200M/(240*1024*1024*1024)*1000≈0.8 ms to process one testing datapoint (with no pipelining available to improve throughput). This throughput is surely acceptable, but memory bandwidth provides an absolute limit on the architecture's overall performance that scales linearly as O(ND). This performance can be improved an order of magnitude by adding multiple memory banks to operate in parallel. The module used in this example uses only 16 wires to interface with this custom embodiment, leaving room for more.

Unfortunately evidence exists that global memory embodiment will perform at much lower throughput than this custom solution. However, the benefit of this embodiment is that it need not have enough components to implement all Hamiltonians. Instead, it can reuse each component for multiple Hamiltonians, relying on memory to provide the current Hamiltonians on which to operate. If the Hamiltonians are processed in G chunks, pausing to load a new chunk of Hamiltonians at the start of each chunk, individual chunks will be of size D/G (where G represents the number of chunks). Most transistor requirements (excluding memory) will also divided by G, providing a mechanism for computing massive models on very affordable hardware. This embodiment would require 1/G as many components, wires, and accompanying component-local memories. The cost, again, is throughput (which is divided by G) and response time (which is approximately multiplied by G).

### L. Simulation on a CPU, GPU, or Non-Traditional Microprocessor

The present embodiments herein are distinguished substantially from von Neumann architectures. However, GPUs, being very different from CPUs, were first developed by simulation on CPU. Similarly, its functions can be simulated on conventional CPUs and/or GPUs. Programmable wires are simulated using a list of destination indices for each source index, or using a sparse numeric or logical matrix W of dimensionality n__{src}×n__{dst}, where each element w_ᵢⱼ stores the number of connections between source i and destination j. Components are simulated by conventional von Neumann instructions and code libraries, in which the architecture's logical values are represented by bytes, and low-bit-width integer values are represented by double-precision floating points. It is noted that simulations are generally task-specific, in which the code is written specifically to simulate each component. However, it can be advantageous to work with task-general simulations (virtual machines), in which the low-level operations of the components are themselves implemented in conventional CPU code. These embodiments have been tested, and found to be more informative about the real-world behavior of the invention.

### M. Algorithm Aii: Adding More-Advanced Components

Having identified an image's parts, the system produces a predetermined set of affine transforms on the parts; these may include translation of a given part to the right or left, up or down, by a set of fixed distances (1, 2, and 3 pixels in each direction, in the present example). These are “learned,” i.e., encoded as though the inputs had occurred in the training data, and their corresponding HNets are stored. The result is that given learned parts can be recognized at multiple different positions in a test image. The transform applied to the Hamiltonian of any given prototype is:

Ĥ\hat{ }prime=P^{T}ĤP.

where P is the permutation operator that transforms the existing Ĥ to a new location.

As described above, these transforms may include translation of a given part by a set of fixed distances (e.g., 1, 2, or 3 pixels) in the four possible directions (up, down, left and right). Note that any arbitrary translations or rotations may be used; the present examples use only 2-pixel translations. These are encoded as though the inputs had occurred in the training data, and their corresponding HNets are stored. Note also that this step could instead be performed at recognition time, at greater cost; the tradeoff has been to spend memory storage space to save time at recognition. The result is that given learned parts can be recognized at multiple different positions in a test image.

Translation is one of many more advanced training-time operations that have been developed and apply to the invention. In the following paragraphs, a discussion is provided of biologically-inspired learning operations.

Reference is made to FIG. 10, which shows an example of a connected part component 1000, drawn on the pixel nodes of an MNIST image. An example of a shared, cross-class connected part component, 1001 is shown, and it displays matching both an image of a two and an image of an eight. Examples of four discriminative connected part components 1002 (two in orange/first shading, two in green/second shading), each of which matches one class of digit and not others.

More particularly, these learning operations are intrinsically linked to the invention. For example, so-called iterative learning approaches for this invention (not further described herein) have been developed. HNet, like a human child, might have been exposed to many images of the digit “2” but no instances of the digit “8” (1002 in FIG. 10). Both would also have a great learning opportunity when first they detected an “8.” Both can label the “8” as a “2.” because they one or more connected part components in common. Both are capable of learning that the topmost connected part 1002 (FIG. 10) is not a discriminant of “2” vs “8,” but that the middle components are such discriminants. In conventional ANNs, values are generally non-negative. This makes it difficult for an ANN to represent a NOT relationship. In this example, the “8” contains a crossed-line component in the center. The “2” does not have such a component, so an ANN can store a large weight from the crossed-line component to the category “8” and a zero-valued weight from the crossed-line component to the category “2.” This fails to capture the logical NOT relationship—not only is the crossed-line component unrelated to the digit “2,” it is incompatible with the “2”—it predicts that the category will NOT be a “2.” HNet separates 00, 01, 10, and 11 relations, so it can capture the XOR relationship between the crossed-line component and other components that predict “2.” This enables the composite Hamiltonians involving the crossed-line component to actively suppress digit “2” representations, without (free of) additional machinery.

FIG. 11 shows a pseudocode for algorithm Ai (1100). H∈int16^{D×D×B}, [symbol] ∈int16^{B×1}, [symbol] ∈ [symbol] ^{784×1}, [symbol] ∈ [symbol] ^{D×1}, energies vector [symbol] ∈int16^{B×1}, distance vector [symbol] ∈int16^{B×1} (where B is the number of components). Function names are in all-caps in this description. Algorithm Ai stage 1 1110 describes construction of initial components. Initial parts are created (1111), using the methods described previously for deriving then compositing Hamiltonians. The next step dilates by 1 pixel (1112). In algorithm Ai stage 2 (1120), the refinement of components occurs using discriminative cues. The algorithm then deletes (1121) low-discriminability connected components. Parts are dilated, and compared w parts from diff *group* to find part-part similarity (bipartite across two groups). In this example, group-group similarity is the mean or max of part-part similarity in this bipartite graph. The algorithm iteratively merges (1122) the most similar pair of groups until we have the desired number of groups, or all group-group similarities are below threshold. The algorithm dilates and intersects the edges with images from any *class* (1123), then add the intersection to the part component bank iff its discriminability is high. Low-discriminability connected components are deleted (1124). Illustratively, steps 1123 and 1124 are performed concurrently.

In algorithm Ai stage 3 (1130) startup occurs. In the algorithm Ai stage 4 (1140), the test image is encoded with components. The algorithm computes energy (1141), and selects the F lowest energies (1142). It produces an F-hot encoding of the components with the lowest energies (1143). In algorithm Ai stage 5 (1150) the class label of the test image is predicted. The algorithm measures the energy of the test image F-hot code with the part→part Hamiltonian for each training image (1151), and finds (1152) the index of the lowest energy. The test image is labeled in algorithm step 1153.

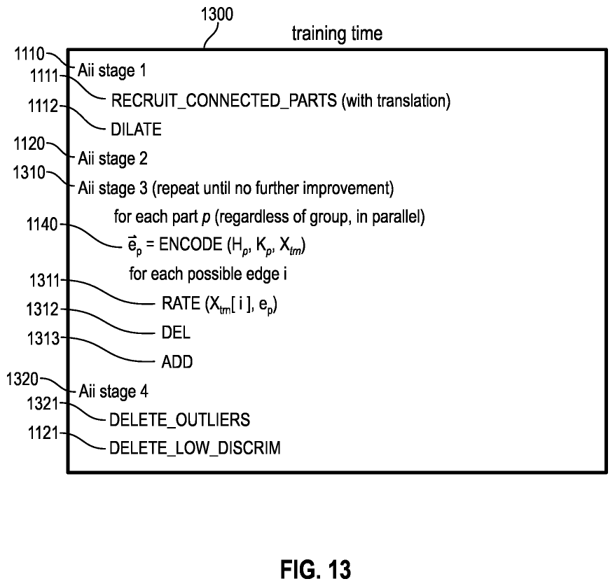

FIG. 13 shows pseudocode for algorithm Aii at training time (algorithm simplified by the removal of competition amongst parts) 1300. The testing task matches that of FIG. 11 (steps 1130, 1140 and 1150). Function names are described herein in all-caps. Algorithm Aii stage 3 (1130) provides expectation-maximization to repeatedly refine components. Stage 3 (1130) is repeated until no further max discriminability improvement. The algorithm finds p's class histogram (1311), measures max slope between classes (think sigmoid), and identifies classes to which p should respond (and classes to which p should *not* respond). The algorithm rates the e→p pair=across trn images, does edge e appear in (and only in) classes to which p should respond. Delete the 1 lowest-rated edge from part p (1312). The algorithm adds the 1 highest-rated edge to part p (1313). Algorithm Aii stage 4 (1320) then performs cleanup operations. The algorithm then deletes (1321) the half of parts whose class histograms most poorly match that of their group.

More particularly, a second learning operation can be written as an expectation maximization (EM) algorithm, which can be termed Aii. Algorithm Aii, at training time, is depicted in (1300 in FIG. 13). Its steps are now described. Algorithm Aii stage 0 “startup” is identical to its form in algorithm Ai. Algorithm Aii stage 1 (1110 in FIG. 11) is identical to its form in algorithm Ai, except that the RECRUIT_CONNECTED_PARTS function (1111 in FIG. 11) can optionally include translated versions of each recruited connected part (as described in previous paragraphs). Algorithm Aii stage 2 (1120 in FIG. 11) is identical to its form in algorithm Ai.

Algorithm Aii stage 3 applies expectation-maximization (EM) to repeatedly refine components (1310 in FIG. 13). An EM algorithm repeatedly performs two sub-steps. The expectation sub-step calculates, from the existing model (set of components), the expected encoding of the training dataset. The maximization sub-step computes a new model (set of components) that improves a measure of goodness (RATE, (1311 in FIG. 13).

The expectation sub-step includes one operation, ENCODE, which measures the energy of the test image, separately using each Hamiltonian in the learned model, as in 1140 (FIG. 11).

The maximization sub-step includes the following operations. RATE (1311 in FIG. 13) produces a scalar rating for every edge in every component. The ratings are stored as small non-negative integers in this embodiment. A rating is a function of the input pixels across training images, the connected part component encoding, and the class labels. For each edge-component-class triplet, the process computes the frequency with which all three co-occur across training images. This generates, essentially, a 3D histogram that can be viewed as a matrix of class histograms (as described previously)—one class histogram for each edge-component pair. The rating for the edge-component pair is the discriminability of their class histogram (as also described previously). DEL (1312 in FIG. 13): For each component, delete the X lowest-rated edges. ADD (1313): For each component, add the X highest-rated edges. In some embodiments. X=1%. Smaller values of X require more repetitions of stage 3 before convergence. Larger values of X may introduce sub-optimal components by changing too many edges simultaneously.

Algorithm Aii stage 4 performs cleanup of unwanted components (1320 FIG. 13). First, DELETE_OUTLIERS (1321 in FIG. 13) is run. For each group, the process removes the Y % of member components that possess class histograms most different from the group mean class histogram. In some embodiments, Y=50%. Second, DELETE_LOW_DISCRIM deletes low-discriminability components, as in step 1121 (FIG. 11).

### N. Algorithm Aiii: Adding Meta Components

Hierarchical networks have famously been utilized in ANNs to improve network performance. In many cases, the nature of the input, as understood in human concepts, is itself hierarchical. This is the case for use case A, in which connected parts often provide context for one another. For an example, refer to element 1002 (FIG. 10), in which the top connected component is undescriminative. However, it provides cues about how to interpret the digit images. The top connected component is generally on top, indicating that the other components in the images must not be on top. Beyond this example, the prior art is replete with other examples, and with many attempts to take advantage of these regularities in imagery.

This invention is capable of operating on such hierarchical architectures. In fact, the invention has several advantages over prior approaches, as described above, it provides an explainability that is lacking in hierarchical ANNs, and new capabilities for deep training tasks.

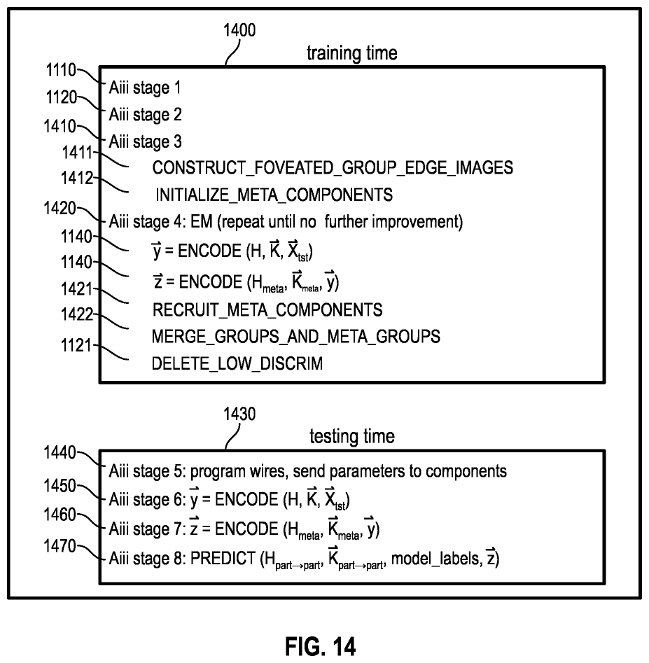

FIG. 14 shows pseudocode for algorithm Aiii (1400). Function names are in all-caps. Algorithm Aiii stage 3 (1410) constructs initial meta components. For each group, place it in the center of a new kind of image (1411). Then, the algorithm creates new 2D square grids (“images”) that represent the relative locations of various groups that matched each training image. Finally, the algorithm find the edges in these group images. The algorithm constructs initial meta components from the foveated group edge images (1412). Algorithm Aiii stage 4 (1420) performs expectation-maximization to repeatedly refine components. It constructs (1421) foveated group edge images, then select components from the training examples (one encoded image=one component). The algorithm merges (1422) foveated components into groups. Testing time sub-portion of algorithm Aiii (1430) then occurs, followed by algorithm Aiii stage 5 that performs startup (1440). Algorithm Aiii stage 6 (1450) performs layer 1 component encoding, and algorithm Aiii stage 7 (1460) performs meta component encoding. Algorithm Aiii stage 8 (1470) performs matching of the encoded testing image to encoded training images, by measurement of energy using the composite part-part Hamiltonian corresponding to each image (this is similar or identical to step 1150 in FIG. 11).

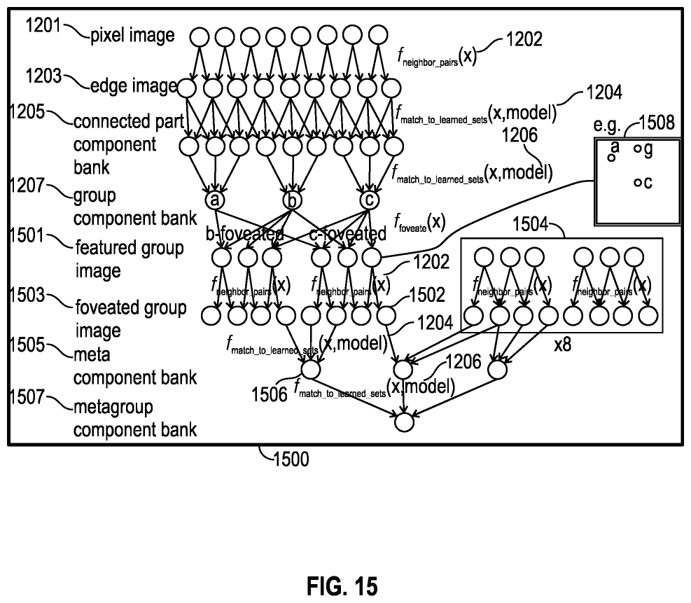

FIG. 15 shows a hardware summary 1500 for an embodiment performing algorithm Aiii at testing time. The foveated group image is a register of numerous foveated group images derived from the inputted pixel image (1501). Each foveated group image contains one pair of groups, one at the center and one at a different position (see below). The foveated group edge image (1502) can represent a mid-level concept such as “group b to the left of group c.” Group “b” can, for example, be a vertical line, and group “c” can be a horizontal one. The foveated group edge image (1503) contains the set of edges amongst pixels in step 1501 that were present. The foveated group images are split into eight replicates, each focused on one location of the non-foveated group relative to the foveated group (1504). Note that there are eight non-center pixels in a 3×3 image. These “atomic” foveated group images can be composited using methods described in text. The meta component bank encoding (1505) contains an array of integers ranged {0,127}. Each value i represents the similarity between the input image and meta component i, measured as the energy of the composite Hamiltonian corresponding to meta component i. This meta component (1506) might contain, for example, a composite representation of the two connected part components drawn in orange in the left side of element 1002 in FIG. 10. The meta group component bank encoding (1507) contains an array of integers ranged {0,127}. An example (1508) is provided of a foveated group edge image, foveated (centered) on group “c.” Groups “a” and “g” are also present in this example image, and their locations are plotted relative to group “c.”

As an illustrative embodiment/example, an algorithm is now described that is based on the previous algorithm Aii (1300 in FIG. 13), but incorporates a higher-level meta component bank. Each meta component consists of edges amongst lower-level components. Those edges take the same form as the lower component bank's edges (630 in FIG. 6). This is a process that can be repeated to form arbitrary-depth networks.

Algorithm Aiii at training time (1400) is depicted in FIG. 14. Its operations are now described. Algorithm Aiii stages 1 and 2 are similar or identical to those described in in steps 1110 and 1120 of FIG. 11. These steps construct the initial connected part components. Algorithm Aiii stage 3 constructs initial meta components (1410 in FIG. 14). The function, CONSTRUCT_FOVEATED_GROUP_EDGE_IMAGES (1411 in FIG. 14) is as follows: For each training image, a set of foveated group images are produced from the set of group components that matched the image, plus the pixel location of their matches. An image is constructed for each pair of groups. One group sits in the middle of the image (it is foveated). The other groups are placed in the image at their locations relative to the first group. An example of a foveated group image, foveated/centered on group “c,” is available in step 1508 (FIG. 15). Generally, ultra-low-resolution (e.g. 3×3) images are constructed containing only two groups. This produces n_matching_groups*(n_matching_groups−1) (where n_matching_groups is the number of groups that matched the image) foveated group images for each image, indexed by the IDs of the groups they present.

When using 3×3 px foveated group images with two groups each, the foveated group images are further subdivided into eight copies; one image for observations wherein the non-foveated group is in the top right, one for observations wherein the non-foveated group is in the top left, and so on. This produces a set of so-called atomic foveated edge images, each of which is unique and uniquely indexed. In practice, it is not required to store all of these possible edge images. Composite Hamiltonians are formed from sets of them.

One foveated group edge image is constructed from one foveated group image by graph encoding of pixel adjacency—the same operation performed to construct edges for connected part components, here and in earlier paragraphs. For a 3×3 image, this operation allocates 12 edges.

The function, INITIALIZE_META_COMPONENTS (1412 in FIG. 14) is as follows: Initially, one meta component is created for each training image. Each meta component contains the composite of all meta group edge images produced in the previous step for the corresponding training image. These edges are not dilated, nor are translated versions considered. However, a version of this step is successfully provided, which separates one meta component (generated to capture one test image) into several, based on cliques in the patterns of co-occurrence of subsets of foveated group images across the training set (discussed further in use case B).

Meta group components are constructed, and combine meta components in exactly the same way as group components combine connected part components. Initially, each meta component can be placed in its own group.

Algorithm Aiii stage 4 applies expectation-maximization (EM) to repeatedly refine components (1420 in FIG. 14). The following operations are repeated until no further improvement. The expectation sub-step includes the following operations. ENCODE measures the energy of the test image, separately using each Hamiltonian in the learned model, as in step 1140 (FIG. 11). Next, a foveated group edge image is constructed for each training image, using the output of the first call to ENCODE. Run ENCODE, as in step 1140 (FIG. 11) on the foveated group edge images, using the meta-component Hamiltonians.

The maximization sub-step includes the following operations. First, in RECRUIT_META_COMPONENTS (1421 in FIG. 14), the process finds all pairs of groups that make similar category distinctions (their class histograms are approximately identical). These groups should act together. Next, the process searches for cliques of groups in this similarity measure. If a clique is found of a size that is within hand-defined limits, a new meta component is generated, which represents the composition of their Hamiltonians. This new meta component is placed in the existing meta group with the most similar mean class histogram. If no existing meta groups share sufficiently similar class histograms (subject to a hand-defined limit), the new meta component is placed in its own group. Next, the process performs MERGE_GROUPS_AND_META_GROUPS (1422 in FIG. 14). This step alternately merges groups as in step 1122 (FIG. 11), and meta groups (again, as in step 1122 in FIG. 11). In this example, the process performs a single group-group merge, and a single meta group-meta group merge. This is the most straightforward implementation, and allows the EM process to proceed slowly—and free of substantial changes in encoding between EM repetitions. The Function DELETE_LOW_DISCRIM deletes low-discriminability foveated components, as in step 1121 (FIG. 11). The philosophy of this step is that groups should only be discarded after an attempt has been made to improve them through meta component recruitment and group merges.

Algorithm Aiii at testing time is depicted in step 1430 (FIG. 14). Its operations are now described. Algorithm Aiii stage 5 performs startup (1440), and initializes the connections with connectivity as required to provide the right pixels to the each component's Hamiltonians. Connections are hierarchical, as presented in FIG. 15 (1500), and described further below. Initialization occurs without recurrence, and then components are initialized to implement the learned Hamiltonians.

Algorithm Aiii stage 6 (1450 in FIG. 14) performs the ENCODE operation. This operation measures the energy of the test image, separately using each Hamiltonian in the learned model, as in step 1140 (FIG. 11). Algorithm Aiii stage 7 (1460) performs one operation. The function ENCODE (as in step 1140) is run again, on the foveated group edge images formed from the output of the first call to ENCODE, using the meta-component Hamiltonians. Algorithm Aiii stage 8 (1470) performs one operation. Then, the function PREDICT is run, as described in step 1150 (FIG. 11).

Note that FIG. 15 (1500) provides an alternate depiction of algorithm Aiii at testing time, described in terms of data registers and operations. For those of skill in the art of ANNs, this alternate depiction may be more familiar.

### O. Use Case B: Consumer Credit Classification Machine

To demonstrate the flexibility in the disclosed invention, an exemplary use case in which 15 exemplary credit application variables are used to predict loan defaulting is described. These variables have no spatial arrangement, so 2D adjacency cannot be used to select a sparse set of edges. First, some pre-processing steps are required (202 in FIG. 2). Categorical variables are each converted to a binary one-hot code. Scalar real-valued variables are each converted to multiple binary values by way of binning. Each such variable is normalized to the range 0 to 1. This range is split into five equally sized subsegments (0 to 0.2, . . . ). For each datapoint, this variable is converted to a one-hot code in which the subsegment it is in (grammar) is assigned a 1, and all other segments are assigned a 0. This provides us with an input buffer 203 in FIG. 2).

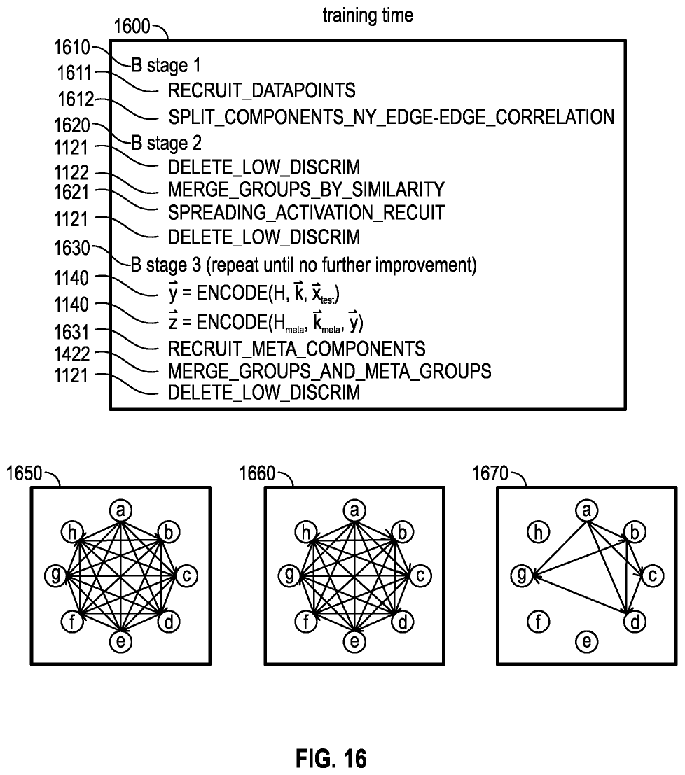

FIG. 16 shows pseudocode for the described algorithm for use case B, at training time 1600. Testing task similarly or identically matches that of listing/procedure 1400 in FIG. 14. Function names are provided in all-caps. Algorithm B stage 1 (1610) entails construction of initial components. The illustrative process/algorithm recruits/extracts (1611) components from datapoints. Each component is split (1612) into multiples. Algorithm B stage 2 (1620) entails refinement of components using discriminative cues. The algorithm recruits (1621) additional components, as described below. Algorithm B stage 3 (1630) performs expectation-maximization to repeatedly refine components and meta components, and recruits/constructs (1631) new meta components (see below). An example of a fully connected directed graph (1650), like the one used to initialize algorithm B is depicted. In use case B, each node is a credit application variable. The graph in block 1650, with connections weighted by the across-datapoint correlation amongst variables (thicker=more correlated) is shown in block 1660. Exemplary credit application variables a, b, and c form a clique of co-varying variables. The edges between variables are more likely to be in the same component than average. An example component (1670), containing the edges amongst a, b, and c is also shown in FIG. 16.

As noted above the process herein defines a new method for selecting edges. For this example, the process initializes the HNet with a fully connected graph-every pair of variables has one of the four basic edge types (400 in FIG. 4) between them. Each edge takes the form already described. This is practical because the number of variables is small.

Algorithm B at training time (1600 in FIG. 16) is now described in further detail. Algorithm B stage 1 constructs initial components (1610). Initially, the process generates one component for each datapoint—each exemplary credit application—via RECRUIT_DATAPOINTS (1611). Component i encodes all of the edges in training image i. Component i is in its own group. Next, the process performs the function SPLIT_COMPONENTS_BY_EDGE-EDGE_CORRELATION (1612). Use case A, derives several components from each training image—one component for each continuously adjacency-connected edge, to a maximum size. Use case B, introduces anew measure of connectedness correlation. For each component i, the process measures how each pair of its edges co-occur across datapoints when they are used to encode the entire training dataset. This produces a set of values that could be visualized as a pairwise co-occurrence matrix. For some components, the co-occurrence matrix will be without structure. For others, there will be cliques or low-dimensional embeddings. In the latter case, the component is split into several. The process assigns each new component to its own group. These components can be grouped based on their class discriminability, not their origin.

Algorithm B stage 2 refines components using discriminative cues (1620 in FIG. 16). Algorithm B stage 2 (1620) is repeated a fixed number of times. DELETE_LOW_DISCRIM deletes low-discriminability foveated components, as in step 1121 (FIG. 11). The function, MERGE_GROUPS_BY_SIMILARITY is performed as in step 1122 (FIG. 11). The function SPREADING_ACTIVATION_RECRUIT (1621) is a variation of the function DILATE_RECRUIT (step 1123 in FIG. 11). Image dilation is undefined for non-spatial datasets. However, the description has already introduced a correlation-based pairwise similarity measure amongst edges. Here, in lieu of dilation, spreading activation theories are emulated. For each edge of component i, the process activates the X most correlated edges to the edge in question. This drastically increases the number of activated edges, selectively choosing those that co-occur with each edge. Next, the process takes the intersection of this activated component with each training image. Each of these intersections becomes a new component, in its own group. DELETE_LOW_DISCRIM deletes low-discriminability foveated components, as in step 1121 (FIG. 11).

Algorithm B stage 3 (1630) applies expectation-maximization (EM) to repeatedly refine components and meta components. First, the process should initialize the meta components. Initially, it creates one meta component for each training datapoint, as in step 1412 (FIG. 14). Unlike the illustrative algorithms for use case A, the process does not construct a set of (foveated) edge images to represent the training datapoint. Instead, the process constructs another fully connected edge graph, this time with one of four edge types between every pair of group components. As always with new components (in algorithm B), each component is placed in its own group. After the initial construction of meta components, the following operations are repeated until no further improvement.

The expectation sub-step includes the following operations. The function, ENCODE measures the energy of the test image, separately using each Hamiltonian in the learned model, as in step 1140 (FIG. 11). Next, ENCODE (as in step 1140, FIG. 11) is run again, on the output of the first call to ENCODE, using the meta-component Hamiltonians. This step is fairly straightforward in that it does not require performance of the foveated group edge image transform.

The maximization sub-step includes the following operations. The function, RECRUIT_META_COMPONENTS (1631) constructs additional meta components. Within each meta group component, the process reviews each edge of each meta component. Such an edge links two lower-level components. Two subsets of these edges are flagged that make different predictions about the dependent variable, as measured by the difference in the class histograms created by encoding the training dataset with each subset separately. If two subsets are sufficiently different (as governed by a hand-determined threshold), the meta component is split into two. For each of the two new meta components, the process identifies meta edges that co-occur with the presence of the meta component in training datapoints. Highly co-occurring edges are added to the component. Finally, the process assigns each new meta component to the group with the most similar class histogram.

The function, MERGE_GROUPS_AND_META_GROUPS proceeds similarly or identically to that in step 1422 (FIG. 14). Groups and meta groups are merged based on similarity. The function, DELETE_LOW_DISCRIM deletes low-discriminability meta components, as in step 1121 (FIG. 11).

For this type of application, an explainable architecture like the current invention is valuable for several reasons. Firstly, loan rejection bears serious consequences to the financial health of an individual. For this reason, applicants will want an explanation of why they were rejected. Such an explanation comes from decomposing the Hamiltonians, to determine which parts of the application predicted loan default. In many environments, it may be both valuable and practical to ascribe paragraphs of explanation to certain partially-decomposed Hamiltonians. Secondly, many bankers would place value on being able to understand what makes a person more likely to default on their loan. From such an explanation, bankers can improve loan application questions.

In both cases, value arises from being able to extract parts of the data space that co-vary and relate to one another in informative ways. Such relational concepts (like the following) have been valuably incorporated into symbol systems: “An applicant who lives in a high-rent neighborhood is only financially secure if they have a high income.” With the proper framework, these concepts can be logically inferred. As an illustrative example, 1670 (FIG. 16) depicts one component that might be learned. It can be assumed herein that this component appears primarily in loans that do not default. Query-what is it about people with this component that makes them a safe investment? In reviewing the edges in this component, it may be determined that they can be described {a OR b, a NIMPL g, b NIMPL g, . . . }. If “a” and “b” are wealthy zip codes, and “g” is a poor zip code, it may be inferred that the component in 1670 is a symbol for wealthy. So far, such operations have been unattainable to ANNs. The illustrative embodiment provides new opportunities in this area through the partial decomposition of learned Hamiltonians.

### III. Conclusion

It should be clear that the above-described system and method advantageously yields radically low-power, low-size, low-weight digital electronics chips, that can run for long durations with little power draw. Studies indicate that the disclosed hardware architecture will significantly outperform current parallel neural systems including specialized neuromorphic hardware and GPUs. Breakthrough devices in the realms of IoT, drones, self-driving cares, and data center computing are made possible by combining novel software that uses intrinsically parallel power-sensitive algorithms together with novel parallel neural-based hardware architectures.

### IV. Bibliography

The following published references described hereinabove are incorporated by reference as useful background information:
1. Amari S (1967) A theory of adaptive pattern classifiers. IEEE Transactions on electronic computers EC-16, 299-307.
2. Bentley J L (1975) Multidimensional binary search trees used for associative searching. Communications of the ACM. 18 (9): 509-517. doi:10.1145/361002.361007.
3. Bowen, E. F., Tofel. B. B., Parcak, S., & Granger, R. (2017). Algorithmic identification of looted archaeological sites from space. Frontiers in ICT, 4.
4. Chandrashekar A & Granger R (2012) Derivation of a novel efficient supervised learning algorithm from cortical-subcortical loops.
5. Chandrashekar et al. (2013) Learning what is where from unlabeled images: joint localization and clustering of foreground objects.
6. Granger (2011) How Brains Are Built: Principles of Computational Neuroscience.
7. Granger et al. (2017) Elemental cognitive acts, and their architecture.
8. Grossberg S (1976) Adaptive Pattern Classification and Universal Recoding. Biol. Cybern. 23: 121-134.
9. Hebb D (1949) The Organization of Behavior. New York: Wiley.
10. Jarrett et al. (2019) Feedforward and feedback processing of spatiotemporal tubes for efficient object localization.
11. Kohonen T (1974) An adaptive memory principle. IEEE Transactions on Computers C-23, 444-445.
12. McCulloch W & Pitts W (1943) A logical calculus of the ideas immanent in nervous activity. The bulletin of mathematical biophysics, 5: 115-133.
13. Meyer Y (1992) Wavelets and Operators. Cambridge, UK: Cambridge University Press.
14. Moorkanikara Nageswaran, J., Felch, A., Chandrasekhar, A., Dutt, N., Granger, R., Nicolau, A., & Veidenbaum, A. (2009). Brain derived vision algorithm on high performance architectures. International journal of parallel programming, 37(4), 345-369.
15. Rodriguez, A., & Granger, R. (2016). The grammar of mammalian brain capacity. Theoretical Computer Science, 633, 100-111.
16. Rodriguez, A. M., & Granger, R. (2017). The differential geometry of perceptual similarity, arXiv preprint arXiv:1708.00138.
17. Rosenblatt F (1958) The Perceptron: A Probabilistic Model For Information Storage And Organization In The Brain. Psych Review. 65: 386-408.
18. Rumelhart D & Zipser D (1985) Feature Discovery by Competitive Learning.
19. Turing AM (July 1948) Intelligent Machinery (Report). National Physical Laboratory.
20. Werbos P (1974) Beyond Regression: New Tools for Prediction and Analysis in the Behavioral Sciences. PhD thesis, Harvard University, Cambridge, MA.
21. Widrow B & Hoff M (1960) Adaptive switching circuits. IRE Westcon Record, Part 4, 96-104.
22. Interconnections for crosswire arrays, WorldWideWeb article-URL address: https://patents.google.com/patent/US20080042299.
23. Mosys whitepaper. BLAZAR BE3-BURST Accelerator Engine Intelligent In Memory Computing. Accessed 3/2022, WorldWideWeb article-URL address: https://static6.arrow.com/aropdfconversion/c4975eO7cfaO5b3c3369be767d73aadbc79be4b 9/mosys-be3burst.pdf.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, as used herein, the terms “process” and/or “processor” should be taken broadly to include a variety of electronic hardware and/or software based functions and components (and can alternatively be termed functional “modules” or “elements”). Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Additionally, as used herein various directional and dispositional terms such as “vertical”, “horizontal”, “up”, “down”, “bottom”. “top”, “side”, “front”, “rear”, “left”, “right”, and the like, are used only as relative conventions and not as absolute directions/dispositions with respect to a fixed coordinate space, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances of the system (e.g. 1-5 percent). Accordingly, this description is meant to be taken only by way of example, and not to otherwise limit the scope of this invention.

What is claimed is:

1. A processing system comprising:
a processor arrangement adapted to handle rich multivariate relational data from sensors or a database in which the relations are implicit.

2. A processing system comprising:
a processor arrangement adapted to learn composable part-whole and part-part relations from data, and matches against new data.

3. The processing system as set forth in claim 2 wherein the relations are composable into symbols of value for distinguishing or associating datapoints.

4. The processing system as set forth in claim 3 wherein the symbols correlate with business and personal use cases.

5. The processing system as set forth in claim 4 wherein the use cases include hand-written digits or a credit score.

6. A processing system organized based upon a plurality of components, comprising:
a processing architecture in which,
(a) inputs to each component, from the plurality of components, comprise an array of integers, predetermined length,
(b) a product of each component a scalar integer,
(c) free of learning, an output of each component only changes as a function of its input,
(d) each component possesses a short list of operations that, respectively, the component is capable of performing and a short list of parameters for each operation,
(e) each component performs only one operation on a given input,
(f) all components are capable of operating independently and in parallel,
(g) components are capable of operating in sequence, or recurrently,
(h) components are extremely sparsely connected,
(i) connectivity is many-to-many, and defined at startup, and
(j) connectivity amongst components can only change using local operations, free of a backprop.

7. The system as set forth in claim 6 wherein the array of integers are ≤8 bit and the predetermined length is a consistent length, and the scalar integer is a ≤8 bit scalar integer.

8. The system as set forth in claim 7 wherein the components can only perform a limited set of operators, comprising:
(a) 2-way or n-way Boolean relational operators,
(b) ≤8-bit integer or unsigned integer addition, and
(c) comparison of above results: argmax, argmin.

9. The system as set forth in claim 8 wherein a subset of operations are composable and reversible/decomposable.

10. The system as set forth in claim 9 wherein operations of the processor architecture are defined by a formality.

11. The system as set forth in claim 10 the formality comprises Hamiltonian Compositional Logic Networks.

12. The system as set forth in claim 11 wherein the operations serve to compare each input to a model of data, stored internally in component parameters and connectivity.

13. The system as set forth in claim 12 wherein the processor is adapted to learn composable part-whole and part-part relations from the input data, and matches against new data, and wherein the matching undergoes reduction steps that convert arrays to shorter arrays or scalars.

14. The system as set forth in claim 13 wherein the arrays and scalars define at least one of (a) k-winner-take-all, (b) thresholding, (c) sum, accumulate, (d) min, argmin, max, argmax, (e) find index of xth quantile, (f) univariate statistics: mean, median, mode, stddev, stderr, and (g) multivariate statistics or correlation.

15. The system as set forth in claim 6 wherein operations are performed on nearest neighbors.

16. The system as set forth in claim 15 wherein the operations use Hamiltonians at least one of implicitly and explicitly.

17. The system as set forth in claim 15 wherein the operations uses exact Hamiltonians.

18. The system as set forth in claim 6 wherein the processor architecture performs learning operations, the learning operations being at least one of symbolic, local and free of gradients.

19. The system as set forth in claim 6 wherein the operations can be carried out via extremely low-precision processing.

20. A method for processing input data with a processor, comprising the steps of:
(a) inputting to each component, from the plurality of components, an array of integers, of predetermined length,
(b) producing with each component a scalar integer,
(c) free of learning, outputting from each component only changes as a function of its input,
(d) processing, for each component, a short list of operations that, respectively, is capable of performing a short list of parameters for each operation,
(e) preforming, for each component, only one operation on a given input,
(f) wherein all components are capable of operating independently and in parallel,
(g) wherein components are capable of operating in sequence, or recurrently,
(h) wherein components are extremely sparsely connected,
(i) wherein connectivity is many-to-many, and defined at startup, and
(j) wherein connectivity amongst components can only change using local operations, free of a backprop.

21. The method as set forth in claim 20 wherein the array of integers are ≤8 bit and the predetermined length is a consistent length, and the scalar integer is a ≤8 bit scalar integer.

22. The method as set forth in claim 21 wherein the components only perform a limited set of operators, comprising:
(a) 2-way or n-way Boolean relational operators,
(b) ≤8-bit integer or unsigned integer addition, and
(c) comparison of above results: argmax, argmin.

23. The method as set forth in claim 22 wherein a subset of the operations are composable and reversible/decomposable.

24. The method as set forth in claim 23, further comprising, defining operations of the processor by a formality.

25. The method as set forth in claim 24 the formality comprises Hamiltonian Compositional Logic Networks.

26. The method as set forth in claim 25 wherein the operations serve to compare each input to a model of data, stored internally in component parameters and connectivity.

27. The method as set forth in claim 26 wherein the processor learns composable part-whole and part-part relations from data, and performs matching against new data, the matching undergoing reduction steps that convert arrays to shorter arrays or scalars.

28. The method as set forth in claim 27 wherein the arrays and scalars define at least one of (a) k-winner-take-all, (b) thresholding, (c) sum, accumulate, (d) min, argmin, max, argmax, (e) find index of xth quantile, (f) univariate statistics: mean, median, mode, stddev, stderr, and (g) multivariate statistics or correlation.

29. The method as set forth in claim 20, further comprising, performing operations on nearest neighbors.

30. The method as set forth in claim 29, further comprising, using Hamiltonians at least one of implicitly and explicitly.

31. The method as set forth in claim 29, further comprising, using exact Hamiltonians.

32. The method as set forth in claim 20, further comprising, performing, with the processor, learning operations, the learning operations being at least one of symbolic, local and free of gradients.

33. The method as set forth in claim 20, further comprising, carrying out, with the processor, operations via extremely low-precision processing.
